(19) United States
(12) Patent Application Publication
(10) Pub. No.: US 2026/0097395 A1
(43) Pub. Date: Apr. 9, 2026

(54) TITANIUM DIOXIDE ASPHALT COMPOSITIONS AND METHODS FOR THEIR APPLICATION

(71) Applicant: CoolSeal LLC, Laguna Niguel, CA (US)

(72) Inventors: Robert Davis Koleas, Laguna Niguel, CA (US); Michael Hamilton March, Durham, NC (US)

(21) Appl. No.: 19/108,704

(22) PCT Filed: Sep. 8, 2023
(86) PCT No.: PCT/US2023/073723

§ 371 Date: Mar. 4, 2025

Related U.S. Application Data
(60) Provisional application No. 63/375,037, filed on Sep. 8, 2022.

(51) Int. Cl. B01J 31/38; B01J 21/02; B01J 21/06; B01J 21/08; B01J 21/16; B01J 23/00; B01J 23/86; B01J 27/232; B01J 31/06; B01J 35/39; B01J 35/40; B01J 37/02

(52) U.S. Cl. CPC B01J 31/38; B01J 21/02; B01J 21/063; B01J 21/08; B01J 21/16; B01J 23/002; B01J 23/862; B01J 27/232; B01J 31/06; B01J 35/39; B01J 35/40; B01J 37/0219

(57) ABSTRACT

An asphalt-based sealcoat composition comprising high levels of titanium oxide particles is provided. In some embodiments, a highly solar reflective asphalt-based sealcoat composition comprising high levels of titanium oxide particles is provided. In some embodiments, an asphalt-based sealcoat composition capable of reducing pollutants comprising high levels of titanium oxide particles is provided. In some embodiments, methods for preparing asphalt-based sealcoat compositions as well as their application to asphalt surfaces is provided.

### CROSS REFERENCE TO RELATED APPLICATIONS

This application claims priority to U.S. Provisional Patent Application Ser. No. 63/375,037, filed Sep. 8, 2022, which is hereby incorporated by reference in its entirety.

### TECHNICAL FIELD

The field of disclosure relates to asphalt-based sealcoat compositions comprising titanium oxide (TiO₂) particles.

### BACKGROUND

The technology to which the invention is directed relates to a sealer used for asphalt substrates, such as a sealer for asphalt of the type employed extensively throughout the United States. Pavement technology has developed a series of asphalt coating compositions. Many of the asphalt compositions have been applied to asphalt, sometimes as a protective coating and sometimes as a re-cover system. Such asphalt mixtures have little or no reflectivity in that they are typically black in color, are not solar reflective, do not reduce surface temperatures, and do not reduce pollutants.

However, it has been found that conventional dark pavements rapidly increase in temperature when exposed to sunlight because they absorb 80-95% of the sunlight and significantly contribute to the creation of heat islands. Heat islands are built up areas that are hotter than nearby rural areas. For example, the annual mean air temperature of a city with one million people or more can be 1.8-5.4° F. (1-3° C.) warmer than its surroundings. In the evening, the difference can be as high as 22° F. (12° C.). Heat islands can affect communities by increasing summertime peak energy demand, air conditioning costs, air pollution and greenhouse gas emissions, heat-related illness and mortality, and water quality. According to Akbari et al., hot pavements aggravate urban heat islands by warming the local air and contribute to global warming by radiating heat into the atmosphere. As pavements comprise about one third of urban surfaces, they are a significant source of heat in urban environments (Akbari H, Rose L S, Taha H. 1999. Characterizing the fabric of the urban environment: A case study of Sacramento, California. Lawrence Berkeley National Laboratory). Moreover, hot pavement can also raise the temperature of storm water runoff, which can cause additional negative impacts. Thus, there exists a real need for lowering asphalt surface temperatures.

In addition, vehicles traveling on asphalt surfaces have been known to produce significant levels of pollutants. While pollutants have long been known to have a negative environmental impact, photocatalytic air cleaning has also been shown to remove polutants including nitrogen oxides (NOx) and volatile organic compounds (VOCs) from polluted urban air, and, consequently, for reducing concentrations of toxic and irritating ozone, a key constituent of smog that forms on hot, sunny days.

Thus, there is a need for technology that reduces asphalt surface temperatures and reduces pollutants via photocatalytic reactions.

### SUMMARY

Given the above background, there is a need for asphalt coating compositions that are highly solar reflective, reduce surface temperatures, and reduce pollutants via photocatalytic reactions. For example, there is a need in the art for improved asphalt coating compositions and methods for applying the same to mitigate the effects of increased surface temperature and pollution due to vehicle traffic in urban environments, such as aggravated heat islands, contributions to global warming, and increased temperatures of storm water runoff.

The present disclosure addresses the shortcomings identified in the art by providing novel, high-performance asphalt-based sealcoat compositions comprising titanium oxide (TiO₂) particles. In some embodiments, the asphalt-based sealcoat composition is highly solar reflective and reduces asphalt surface temperatures and pollutants.

Accordingly, in one aspect, the present disclosure relates to an asphalt-based sealcoat composition comprising an asphalt emulsion, water, an extender, sand, a polymer emulsion, clay, fiber, and a plurality of titanium oxide (TiO₂) particles, where the TiO₂ is present in the composition in an amount of about 10% to about 60% by weight.

In some embodiments, the present disclosure provides an asphalt-based sealcoat composition comprising an asphalt emulsion, water, an extender, sand, a polymer emulsion, clay, fiber, and a plurality of titanium oxide (TiO₂) particles, where the TiO₂ is present in the composition in an amount of about 18% to about 50% by weight.

In some embodiments, the present disclosure provides an asphalt-based sealcoat composition comprising an asphalt emulsion, water, an extender, sand, a polymer emulsion, clay, fiber, and a plurality of titanium oxide (TiO₂) particles, where the TiO₂ is present in the composition in an amount of about 21% to about 30% by weight.

In another aspect, the present disclosure relates to an asphalt-based sealcoat composition that is highly solar reflective. In some embodiments, the asphalt-based sealcoat has a SR (Solar Reflectivity) number of at least about 0.10. In some embodiments, the asphalt-based sealcoat of the present disclosure has a SR # of at least about 0.30. In some embodiments, the asphalt-based sealcoat of the present disclosure has a SR # of at least about 0.35. In some embodiments, the asphalt-based sealcoat of the present disclosure has an SRI (Solar Reflective Index) # of at least about 10. In some embodiments, the asphalt-based sealcoat of the present disclosure has an SRI # of at least about 30. In some embodiments, the asphalt-based sealcoat of the present disclosure has an SRI # of at least about 35.

In some embodiments, the present disclosure relates to an asphalt-based sealcoat composition that is capable of reducing surface temperatures of asphalt treated with the asphalt-based sealcoat composition relative to asphalt not treated with asphalt-based sealcoat composition.

In another aspect, the present disclosure relates to an asphalt-based sealcoat composition that reduces pollutants. In some embodiments, the asphalt-based sealcoat composition reduces atmospheric pollutants including an amount of nitrogen oxides (NOx) and volatile organic compounds (VOC) via photocatalytic reactions. In some embodiments, the titanium dioxide acts as a catalyst, reacting with nitrogen oxides and other pollutants to chemically alter them into non-hazardous or less hazardous materials through photocatalytic oxidation (PCO) and/or reduction reaction.

In another aspect, the present disclosure relates to an asphalt-based sealcoat composition that provides anti-skid properties. In some embodiments, the asphalt-based sealcoat of the present disclosure has a skid number SN40R of at least about 25. In some embodiments, the asphalt-based sealcoat of the present disclosure has an SN40R of at least about 30. In some embodiments, the asphalt-based sealcoat of the present disclosure has an SN40R of at least about 35. In some embodiments, the asphalt-based sealcoat has a dynamic friction test (DFT) value of at least about 0.35. In some embodiments, the asphalt-based sealcoat has a DFT value of at least about 0.4. In some embodiments, the asphalt-based sealcoat has a DFT value of at least about 0.45.

Another aspect of the present disclosure provides a method of treating an asphalt surface by applying an amount of the asphalt-based sealcoat composition disclosed herein to the upper surface of the asphalt surface (e.g., roads, playgrounds, parks, parking lots, driveways, residential areas, schools, bike paths, shade structures, roofing, and LEED-certified building projects).

The present technology relates primarily to the treatment of any asphalt surface including roads, playgrounds, parks, parking lots, driveways, residential areas, schools, bike paths, shade structures, roofing, and LEED-certified building projects.

### INCORPORATION BY REFERENCE

All references cited herein are incorporated herein by reference in their entirety and for all purposes to the same extent as if each individual publication or patent or patent application was specifically and individually indicated to be incorporated by reference in its entirety for all purposes. In the event of a conflict between a term herein and a term in an incorporated reference, the term herein controls.

### DETAILED DESCRIPTION

### I. Definitions and Abbreviations

As used herein, the terms “about” or “approximately” refer to an acceptable error range for a particular value as determined by one of ordinary skill in the art, which can depend in part on how the value is measured or determined, e.g., the limitations of the measurement system. For example, “about” can mean within 1 or more than 1 standard deviation, per the practice in the art. “About” can mean a range of +20%, +10%, +5%, or +1% of a given value. The term “about” or “approximately” can mean within an order of magnitude, within 5-fold, or within 2-fold, of a value. Where particular values are described in the application and claims, unless otherwise stated the term “about” meaning within an acceptable error range for the particular value should be assumed. The term “about” can have the meaning as commonly understood by one of ordinary skill in the art. The term “about” can refer to +10%. The term “about” can refer to +5%.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention. For example, as used herein, the term “between” used in a range is intended to include the recited endpoints. For example, a number “between X and Y” can be X, Y, or any value from X to Y.

As used herein, the singular forms “a,” “an,” and “the” include the plural forms as well, unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements, or for use of a “negative” limitation. Furthermore, to the extent that the terms “including,” “includes,” “having,” “has,” “with,” or variants thereof are used in either the detailed description and/or the claims, such terms are intended to be inclusive in a manner similar to the term “comprising.”

As used herein, the term “asphalt” or “oil” refers to a bituminous material that is a constituent of petroleum. Asphalt is frequently used as a paving agent, typically in surface applications. Asphalt may be found naturally or manufactured (e.g., refined) from petroleum, and can take a viscous, liquid form (e.g., at high temperatures), semi-solid form (e.g., at room temperature), or solid form. As used herein, the term “asphalt emulsion” refers to liquid asphalt that has been emulsified in water. In some embodiments, an asphalt emulsion further comprises an emulsifying agent (e.g., a surfactant). Typically, an asphalt emulsion consists of from about 40% to about 85% asphalt (e.g., from about 50% to about 75% asphalt) In some embodiments, an asphalt emulsion comprises additional components, including latex, polymers, acids, and/or other additives to further modify the physical or structural characteristics of the emulsion. See, for example, Asphalt Paving Association of Iowa, “Asphalt Paving Design Guide,” available on the Internet at apai.net/Files/content/DesignGuide/AsphaltCompositeSmFst.pdf.

As used herein, the term “aggregate” refers to any hard, inert, mineral material used for mixing in graduated fragments. In some embodiments, aggregate can comprise gravel, crushed stone, slag, glass, rubber, and/or other suitable materials not otherwise classified herein or of a finer or coarser grade than those classified herein. In some instances, aggregates function to provide strength and load support in asphalt-based compositions after application and compacting. Aggregate particles can be course, fine, graded, dense, and/or open, depending on the method of production or selection of aggregate materials.

As used herein, the term “extender” or “filler” refers to a component of asphalt-based compositions used to modulate the consistency of the respective composition. For example, in some embodiments, an extender is used to stiffen or toughen asphalt binder in an asphalt-based composition. In some instances, an extender is used to improve the adhesion of the asphalt emulsion to the aggregate, to promote dispersion of the asphalt emulsion in the asphalt-based composition, increase the stiffness of the composition, accelerate the curing of compacted mixture (e.g., after application), and/or reduce stripping or moisture damage in the applied asphalt-based composition. In some embodiments, the extender comprises material that is of a similar or identical substance as that contained in the aggregate. In some embodiments, the extender refers to a portion of aggregate that is suspended in an asphalt binder without a particle-particle contact.

The terms “Solar Reflectivity” “reflectance” and “R” refer to the ability of a material to reflect solar energy from its surface back into the atmosphere. The SR value is a number from 0 to 1.0. A value of 0 indicates that the material absorbs all solar energy and a value of 1.0 indicates total reflectance.

The terms “Solar Reflectance Index” and “SRI” refer to the index used for compliance with LEED requirements and is calculated according to ASTM E 1980 using values for reflectance and emissivity. Emissivity is a material's ability to release absorbed energy.

The abbreviations used herein generally have their conventional meaning and are readily appreciated by those skilled in the art. Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. For instance, any of the compositions provided herein may be substituted, modified, added, subtracted, and/or combined with any suitable component of asphalt-based sealcoat compositions, as will be apparent to one skilled in the art. Any recited method can be carried out in the order of events recited or in any other order which is logically possible.

### II. Introduction

As described above, there is a need for asphalt-based sealcoat compositions that are highly solar reflective, reduce surface temperatures, and reduce pollutants.

Accordingly, the present disclosure provides novel compositions, as well as formulations containing such compositions or combinations of these compositions and methods for applying such compositions, that can be used for, among other things, treating an asphalt surface. For example, one aspect of the present disclosure provides asphalt-based sealcoat compositions that exhibit solar reflective and photocatalytic activity. For example, in some embodiments, the asphalt-based sealcoat composition is highly solar reflective with a Solar Reflective Index number of at least about 30 or at least about 35. In addition, in some embodiments, the asphalt-based sealcoat composition has a Solar Reflectivity number of at least about 0.30 or at least about 0.35.

Advantageously, in some embodiments, the asphalt-based sealcoat composition is capable of reducing surface temperatures of asphalt treated with the asphalt-based sealcoat composition relative to asphalt not treated with asphalt-based sealcoat composition. Furthermore, in some embodiments, the asphalt-based sealcoat composition reduces atmospheric pollutants via photocatalytic reactions, including such pollutants as nitrogen oxides (NOx) and volatile organic compounds (VOC).

In addition to the benefits identified above, in some embodiments, the present disclosure provides asphalt coatings that improve upon various preparation, application, durability, storage and safety properties over conventional asphalt and asphalt coatings.

For instance, in some implementations, sand and/or aggregate is mixed into the composition prior to application. Advantageously, such compositions overcome the limitations of conventional methods for preparing asphalt emulsions. In particular, many types of aggregate, including sand, are difficult to stabilize prior to application of the product to a surface. Conventional approaches for the repair or resurfacing of an existing pavement include either dropping aggregate on top of a binder and pressing the aggregate into the binder (i.e., where the aggregate is not mixed prior to application) or mixing the aggregate with the binder onboard at point of application. Adding aggregate earlier in the process generally results in separation and/or undesirable reactions with the emulsion, which can clog equipment and cause uneven application. Moreover, emulsions are typically destabilized upon contact with an aggregate. For instance, traditional asphalt-based compositions suffer from an inability to maintain sand in suspension, especially when the amount of sand is high, e.g., about 5% or more. Thus, the present disclosure provides asphalt based sealcoat compositions comprising aggregate and/or sand that exhibit improved stability and consistency compared to traditional emulsions. Aggregate can also be selected based on the capacity of the material to increase or decrease the hardness of the sealcoat compositions after application.

Furthermore, the present disclosure provides asphalt-based sealcoat compositions that include fiber. In some implementations, the addition of fiber improves the application of the composition to a surface and provides flexibility and longevity to the sealcoat once applied (e.g., by reducing brittleness and cracking). Typically, fiber interactions are dictated by the aspect ratio between length and diameter (among other factors like bend angle, fracture, etc.). Conventional asphalt-related products usually have long, strong fibers for elongation strength and resistance to cracking or raveling, thus providing mechanical strength in the final products. For instance, fibers in a slurry are typically much longer than the fibers used in a sealcoat so that they can interact with (e.g., “trap”) the aggregate. As such, fibers used for a slurry are generally not suitable for a sealcoat.

In contrast, the compositions and methods of the present disclosure improve upon conventional compositions and methods by providing asphalt-based sealcoat compositions comprising fiber. In addition to generating a thickening effect, which can, in some implementations, increase the stability of the composition during storage and transportation, the inclusion of fiber in the presently disclosed sealcoat compositions increases the ease and efficacy with which the sealcoat can be applied to a surface. In particular, fibers in solution impart non-Newtonian properties to the product, allowing the composition to flow like a liquid under stress while returning to a solid-like state once force is released. Thus, fiber imparts “dry” properties (e.g., resistance to stretching, formation of a mat-like structure in the sealcoat to improve durability, etc.) as well as “wet” properties to the colored asphalt-based sealcoat composition.

The benefits of the presently disclosed compositions and methods are further highlighted in comparison to the deficiencies in the art. For example, in some implementations, the presently disclosed asphalt-based sealcoat composition is thick enough such that it is much more stable than conventional slurries or other conventional asphalt-based coating products. As described above, conventional asphalt-based products are either not mixed prior to application or mixed onboard with a short workability window (e.g., about 10-30 minutes for a slurry). In contrast, the claimed asphalt-based sealcoat composition is stable for a substantially longer period of time (e.g., at least 1 day, at least 1 week, at least 1 month, at least 3 months, at least 6 months, at least 1 year, and/or at least 2 years). The presently disclosed compositions and methods remove the need for additional mixing equipment or processes and allow the asphalt-based sealcoat compositions to be applied at the convenience of the user with minimal time constraints.

Additionally, while thick enough to allow for long storage times, the presently disclosed asphalt-based sealcoat compositions are thin enough to be applied without clogging. As such, the presently disclosed asphalt-based sealcoat compositions are stable during storage (e.g., in a vessel such as a can), during application (e.g., via pumping, squeegeeing, or spraying), and after application (e.g., while drying on a surface). In particular, the asphalt-based sealcoat compositions are capable of behaving like a solid under low shear or minimal external forces (e.g., such that it will not run off the road into the sewers) and like a liquid under some mechanical force, allowing it to also flow, e.g., to be sprayed or pumped, during application. In some embodiments, the improved stability and applicability is due in part to the inclusion of fiber in the asphalt-based sealcoat compositions.

The presently disclosed asphalt-based sealcoat compositions also provide improved anti-skid properties to surfaces after application. For instance, the asphalt-based sealcoat compositions can achieve a skid number (SN40R) of at least 30, at least 35, or at least 40. In some implementations, the asphalt-based sealcoat compositions achieve a dynamic friction test (DFT) value of at least 0.35, at least 0.40, or at least 0.45. In some embodiments, the improved resistance to skid is due in part to the inclusion of sand in the asphalt-based sealcoat compositions.

The present technology relates primarily to the treatment of any asphalt surface, including roads, playgrounds, parks, parking lots, driveways, recreational facilities, outdoor facilities, residential areas, schools, bike paths, shade structures, roofing, and LEED-certified building projects.

### III. Asphalt-Based Sealcoat Composition

In one aspect, the present disclosure provides a composition. In an exemplary embodiment, the invention is a composition described herein. In an exemplary embodiment, the invention is a composition according to a formula described herein.

One aspect of the present disclosure provides an asphalt-based sealcoat composition comprising an asphalt emulsion, water, an extender, sand, a polymer emulsion, clay, fiber, and a plurality of titanium oxide (TiO2) particles present in an amount of about 10% to about 60% by weight.

In an example embodiment, the asphalt emulsion is present in an amount of about 20% by weight, the water is present in the amount of about 25% by weight, the extender is present in an amount of about 4.1% by weight, the sand is present in an amount of about 7% by weight, the polymer emulsion is present in an amount of about 13.8% by weight, the clay is present in an amount of about 3.4% by weight, the fiber is present in an amount of about 0.6% by weight, and TiO2 is present in an amount of from about 21% to about 30% by weight, where the asphalt emulsion comprises SS-1h, the extender comprises granulated calcium carbonate, the sand has a particle size mesh of about 200, the polymer emulsion comprises acrylic latex, and the clay comprises Bentonite clay, and where the composition further comprises biocide present in an amount of about 0.2% by weight.

In another example embodiment, the asphalt emulsion is present in an amount of about 20% by weight, the water is present in the amount of about 26% by weight, the extender is present in an amount of about 17% by weight, the sand is present in an amount of about 7% by weight, the polymer emulsion is present in an amount of about 13.6% by weight, the clay is present in an amount of about 3.3% by weight, the fiber is present in an amount of about 0.6% by weight, and TiO₂ is present in an amount of about 10% by weight, where the asphalt emulsion comprises SS-1h, the extender comprises granulated calcium carbonate, the sand has a particle size mesh of about 200, the polymer emulsion comprises acrylic latex, and the clay comprises Bentonite clay, and where the composition further comprises biocide present in an amount of about 0.2% by weight.

One skilled in the art will appreciate that other combinations of components, and any proportions thereof, for the asphalt-based sealcoat composition are possible, as disclosed further herein.

### Titanium Oxide

In some embodiments, the asphalt-based sealcoat composition comprises titanium oxide particles.

In some embodiments, the titanium oxide (TiO₂) particles are present in the composition in an amount of from about 10% to about 60% by weight.

In some embodiments, the TiO₂ particles are present in an amount of from about 18% to about 60% by weight. In some embodiments, the TiO₂ particles are present in an amount of from about 18% to about 50% by weight. In some embodiments, the TiO₂ particles are present in an amount of from about 18% to about 40% by weight. In some embodiments, the TiO₂ particles are present in an amount of from about 21% to about 30% by weight.

In some embodiments, the TiO₂ particles are present in an amount of about 27.8% by weight. In some embodiments, the TiO₂ particles are present in an amount of about 24.2% by weight. In some embodiments, the TiO₂ particles are present in an amount of about 23.9% by weight.

In some embodiments, the TiO₂ particles are present in an amount of about 10% by weight.

In some embodiments, the TiO₂ particles are present in an amount of at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, or at least 30% by weight. In some embodiments, the TiO₂ particles are present in an amount of at least 32%, at least 33%, at least 34%, at least 35%, at least 40%, at least 45%, at least 50%, at least 55%, at least 60%, at least 65%, at least 70%, or at least 75% by weight.

In some embodiments, the TiO₂ particles are present in an amount of no more than 90%, no more than 75%, no more than 70%, no more than 65%, no more than 60%, no more than 55%, no more than 50%, no more than 45%, no more than 40%, no more than 35%, no more than 30%, no more than 29%, no more than 28%, no more than 27%, no more than 26%, no more than 25%, no more than 24%, no more than 23%, no more than 22%, no more than 21%, no more than 20%, no more than 19%, no more than 18%, no more than 17%, no more than 16%, no more than 15%, no more than 10%, or no more than 9% by weight.

In some embodiments, the TiO₂ particles are present in an amount of from about 5% to about 80%, from about 5% to about 60%, from about 10% to about 50%, from about 25% to about 40%, from about 10% to about 35%, from about 25% to about 30%, or from about 15% to about 30% by weight. In some embodiments, the TiO₂ particles are present in an amount of from about 5% to about 20%, from about 8% to about 15%, from about 3% to about 30%, from about 4% to about 40%, from about 9% to about 25%, or from about 10% to about 20% by weight. In some embodiments, the TiO₂ particles are present in an amount of from about 8% to about 40%, from about 10% to about 80%, from about 50% to about 90%, from about 20% to about 70%, from about 25% to about 35%, or from about 20% to about 50% by weight.

In some embodiments, the TiO₂ particles are present in an amount falling within another range starting no lower than about 5% by weight and ending no higher than about 90% by weight.

In some embodiments, the TiO₂ particles comprise an anatase powder form of TiO₂. In some embodiments, the TiO₂ particles comprise a brookite powder form of TiO₂. In some embodiments, the TiO₂ particles comprise a rutile powder form of TiO₂. In some embodiments, the TiO₂ particles comprise anatase powder form of TiO₂, a brookite powder form of TiO₂, a rutile powder form of TiO₂, or any mixture of any combination thereof.

In some embodiments, each respective TiO₂ particle in the plurality of TiO₂ particles comprises a modifier. In some embodiments, the modifier is a surface treatment, where each respective TiO₂ particle comprises a coating. Advantageously, in some implementations, the coating increases the compatibility of the TiO₂ particles with other materials. In some implementations, the coating reduces undesirable interactions of the TiO₂ particles with the environment. In some embodiments, the coating provides enhanced mechanical properties for the TiO₂ particles such as resistance to chalking, scrubbing, and/or loss of color. Chalking of the applied composition can occur due to degradation or disintegration of a binder and/or resin in a composition (e.g., due to weather and/or UV exposure). Scrub resistance generally refers to the ability of the applied composition to resist wearing or degradation. In some embodiments, the coating improves gloss and opacity of the composition, reduces agglomeration of the composition (e.g., during storage), and/or reduces water absorption on the surface of the TiO₂ particles.

In some embodiments, the coating is bonded to the surface of the TiO₂ particle and, as a result, is highly durable. In some embodiments, the modifier is an aluminum hydroxide coating. In some embodiments, the modifier is an inorganic coating selected from the group consisting of titanium, zirconium, silicon and aluminum compounds, or a pharmaceutically acceptable salt, solvate, hydrate, cocrystal, or prodrug thereof. Suitable embodiments for modifiers of TiO₂ particles are further described, e.g., in “Titanium Dioxide Products,” Ishihara Sangyo Kaisha, Ltd., available on the Internet at iskweb.co.jp; Kerr-McGee Chemical LLC, “Tailoring TiO2 Treatment Chemistry To Achieve Desired Performance Properties,” PCI Magazine, 2000, available on the Internet at pcimag.com/articles/86202-tailoring-tio2-treatment-chemistry-to-achieve-desired-performance-properties; and Veronovski, “TiO2 Applications as a Function of Controlled Surface Treatment, Titanium Dioxide-Material for a Sustainable Environment,” IntechOpen, 2018, doi: 10.5772/intechopen. 72945, each of which is hereby incorporated herein by reference in its entirety.

In some embodiments, each respective TiO₂ particle in the plurality of TiO₂ particles has a size of no more than 20 microns. In some embodiments, each respective TiO₂ particle in the plurality of TiO₂ particles has a size of no more than 10 microns. In some embodiments, each respective TiO₂ particle in the plurality of TiO₂ particles has a size of no more than 5 microns. In some embodiments, each respective TiO₂ particle in the plurality of TiO₂ particles has a size of no more than 25, no more than 20, no more than 18, no more than 15, no more than 12, no more than 10, no more than 8, no more than 5, no more than 4, no more than 3, or no more than 2 microns. In some embodiments, each respective TiO₂ particle in the plurality of TiO₂ particles has a size of at least 0.05, at least 0.08, at least 0.1, at least 0.3, at least 0.5, at least 0.8, at least 1, or at least 1.5 microns. In some embodiments, each respective TiO₂ particle in the plurality of TiO₂ particles has a size of from about 0.05 to about 5, from about 0.1 to about 8, from about 0.5 to about 10, from about 0.5 to about 5, from about 1 to about 3, from about 1 to about 20, or from about 5 to about 15 microns. In some embodiments, each respective TiO₂ particle in the plurality of TiO₂ particles has a size that falls within another range starting no lower than 0.05 microns and ending no higher than 25 microns.

In some embodiments, at least 50% of the TiO₂ particles in the plurality of TiO₂ particles have the same or nearly the same particle size (e.g., the size of the TiO₂ particles have a tight distribution). In some embodiments, at least 30%, at least 40%, at least 50%, at least 60%, at least 70%, at least 75%, at least 80%, at least 85%, at least 90%, at least 95%, at least 98%, or at least 99% of the TiO₂ particles in the plurality of TiO₂ particles have the same or nearly the same particle size.

In some embodiments, all of the TiO₂ particles have a particle size of no more than 10 microns (e.g., from about 1 to about 3 microns). Advantageously, in some embodiments, the particle size of no more than 10 microns provides improved stability of the presently disclosed compositions and allows for a more even application of the product to a surface. For example, in some implementations, the TiO₂ particles having a particle size of no more than 10 microns allows for a homogenous distribution of TiO₂ particles in the asphalt-based sealcoat composition and results in fewer microdomains having uneven distributions of various components (e.g., asphalt, pigment, polymer, etc.).

### Asphalt

In some embodiments, the asphalt-based sealcoat composition comprises asphalt emulsion.

In some embodiments, the asphalt emulsion is present in an amount of from about 5% to about 40% by weight. In some embodiments, the asphalt emulsion is present in an amount of from about 10% to about 35% by weight. In some embodiments, the asphalt emulsion is present in an amount of from about 15% to about 30% by weight. In some embodiments, the asphalt emulsion is present in an amount of from about 15% to about 25% by weight. In some embodiments, the asphalt emulsion is present in an amount of from about 18% to about 23% by weight. In some embodiments, the asphalt emulsion is present in an amount of about 20% by weight. In some embodiments, the asphalt emulsion is present in an amount of about 21.7% by weight.

In some embodiments, the asphalt emulsion is present in an amount of at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 45%, at least 50%, at least 55%, at least 60%, at least 65%, or at least 70% by weight.

In some embodiments, the asphalt emulsion is present in an amount of no more than 80%, no more than 75%, no more than 70%, no more than 65%, no more than 60%, no more than 55%, no more than 50%, no more than 45%, no more than 40%, no more than 35%, no more than 30%, no more than 29%, no more than 28%, no more than 27%, no more than 26%, no more than 25%, no more than 24%, no more than 23%, no more than 22%, no more than 21%, no more than 20%, no more than 19%, no more than 18%, no more than 17%, no more than 16%, no more than 15%, or no more than 10% by weight.

In some embodiments, the asphalt emulsion is present in an amount of from about 5% to about 80%, from about 10% to about 60%, from about 15% to about 50%, from about 15% to about 40%, from about 18% to about 30%, from about 20% to about 25%, from about 8% to about 20%, from about 10% to about 30%, from about 5% to about 25%, from about 30% to about 50%, or from about 10% to about 70% by weight. In some embodiments, the asphalt emulsion is present in an amount falling within another range starting no lower than about 5% by weight and ending no higher than about 80% by weight.

In some embodiments, the asphalt emulsion is selected from the group consisting of CSS-1h, CSS-1, SS-1h, SS-1, clay-based emulsions, and/or any mixture thereof.

In some embodiments, the asphalt emulsion is a rapid set (RS), medium set (MS), slow set (SS), or quick set (QS) emulsion. In some embodiments, the asphalt emulsion is a cationic emulsion or an anionic emulsion. In some embodiments, the asphalt emulsion is a high float (HF) emulsion.

Any asphalt emulsion suitable for the preparation of asphalt-based compositions is contemplated in the amounts disclosed herein for the compositions of the present disclosure, as will be apparent to one skilled in the art, including but not limited to RS-1, RS-2, MS-1, MS-2, MS-2h, HFMS-1, HFMS-2, HFMS-2h, HFMS-2s, SS1, SS1h, CRS-1, CRS-2, CRS-2p, CM2, CM2h, CMS-2, CMS-2h, CSS-1, CSS-1h, CSS-1 hp, and/or CQS-1h.

In some embodiments, the asphalt emulsion is selected from the group consisting of penetration grade 40-50 emulsions, penetration grade 60-70 emulsions, penetration grade 85-100 emulsions, penetration grade 120-150 emulsions, and penetration grade 200-300 emulsions. In some embodiments, the asphalt emulsion is a penetration grade 60 emulsion.

Penetration grading is used to characterize the consistency of asphalt mixes, particularly as measured with respect to penetration depth (e.g., of a 100 g needle at 25° C.). For instance, penetration grades 40-50 indicate the hardest grades, penetration grades 60-70 and 85-100 refer to commonly used grades in temperate climates, and penetration grades 200-300 indicate the softest grades, typically used for cold climates. See, for example, Roberts et al., 1996, Hot Mix Asphalt Materials, Mixture Design, and Construction. National Asphalt Pavement Association Education Foundation, Lanham, MD, which is hereby incorporated herein by reference in its entirety.

In some embodiments, the asphalt emulsion comprises a single type (e.g., penetration grade, mixing grade, ionic classification, etc.) of asphalt emulsion. In some embodiments, the asphalt emulsion comprises a plurality of types of asphalt emulsion. In some embodiments, where the composition comprises a plurality of types of asphalt emulsions, each type of asphalt emulsion in the plurality of asphalt emulsions is present in an amount (e.g., percent by weight) disclosed herein. In some such embodiments, each type of asphalt emulsion in the plurality of asphalt emulsions is present in the same amount (e.g., percent by weight) relative to the composition. In some such embodiments, two or more types of asphalt emulsion in the plurality of asphalt emulsions are present in different amounts (e.g., percent by weight) relative to the composition. In some embodiments, where the composition comprises a plurality of types of asphalt emulsions, the amount of asphalt emulsion present in the composition (e.g., as disclosed herein) indicates the total amount of asphalt emulsion in the plurality of asphalt emulsions.

In some embodiments, the asphalt emulsion further includes one or more components for asphalt reinforcement. In some embodiments, the one or more asphalt reinforcement components are selected from the group consisting of mineral asphaltenes (e.g., gilsonite), clarified asphalt (e.g., clear asphalts), and bio-based asphalt-like binders (e.g., soy, corn, palm, flax, algae, kelp, linseed, start, cellulose, collagen, etc.). In some embodiments, the one or more asphalt reinforcement components include bio-rejuvenators. Advantageously, asphalt reinforcement components can provide flexibility in the asphalt-based sealcoat composition, allowing for modification of harder asphalt types and/or the inclusion of a variety of different asphalt types.

In some embodiments, the asphalt emulsion is a polymer-modified asphalt emulsion. For instance, as described below, in some implementations, a polymer emulsion is included in the asphalt emulsion prior to adding the asphalt emulsion to the asphalt-based sealcoat composition. For instance, asphalt emulsions classified with a “P” suffix generally refer to asphalt emulsions that have been supplemented with polymer. In another example, asphalt emulsions classified with an “L” suffix generally refer to asphalt emulsions that have been supplemented with a latex polymer.

In some embodiments, the asphalt emulsion does not contain added polymers, and polymers are added to the asphalt-based sealcoat composition separately from the asphalt emulsion. Suitable polymers contemplated for use in the present disclosure are discussed in greater detail in the section entitled “Polymer Emulsion,” below.

### Water

In some embodiments, the asphalt-based sealcoat composition comprises water.

In some embodiments, the water is present in an amount of from about 15% to about 45% by weight. In some embodiments, the water is present in an amount of from about 18% to about 35% by weight. In some embodiments, the water is present in an amount of from about 20% to about 30% by weight. In some embodiments, the water is present in an amount of from about 20% to about 28% by weight. In some embodiments, the water is present in an amount of about 20.7% by weight. In some embodiments, the water is present in an amount of from about 22% to about 28% by weight. In some embodiments, the water is present in an amount of about 25% by weight.

In some embodiments, the water is present in an amount of at least 5%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 45%, or at least 50% by weight.

In some embodiments, the water is present in an amount of no more than 60%, no more than 55%, no more than 50%, no more than 45%, no more than 40%, no more than 35%, no more than 30%, no more than 29%, no more than 28%, no more than 27%, no more than 26%, no more than 25%, no more than 24%, no more than 23%, no more than 22%, no more than 21%, no more than 20%, no more than 19%, no more than 18%, no more than 17%, no more than 16%, no more than 15%, or no more than 10% by weight.

In some embodiments, the water is present in an amount of from about 5% to about 10%, from about 10% to about 30%, from about 15% to about 50%, from about 15% to about 40%, from about 18% to about 25%, from about 20% to about 23%, or from about 30% to about 60% by weight. In some embodiments, the water is present in an amount falling within another range starting no lower than about 5% by weight and ending no higher than about 60% by weight.

### Polymer Emulsion

In some embodiments, the asphalt-based sealcoat composition comprises polymer emulsion. In some embodiments, the asphalt-based sealcoat composition does not comprise a polymer emulsion.

In some embodiments, the polymer emulsion is present in an amount of from about 1% to about 35% by weight. In some embodiments, the polymer emulsion is present in an amount of from about 2% to about 30% by weight. In some embodiments, the polymer emulsion is present in an amount of from about 3% to about 25% by weight. In some embodiments, the polymer emulsion is present in an amount of from about 4% to about 20% by weight. In some embodiments, the polymer emulsion is present in an amount of from about 6% to about 17% by weight. In some embodiments, the polymer emulsion is present in an amount of about 15% by weight. In some embodiments, the polymer emulsion is present in an amount of about 13.8% by weight. In some embodiments, the polymer emulsion is present in an amount of from about 5% to about 10% by weight. In some embodiments, the polymer emulsion is present in an amount of from about 6% to about 8% by weight. In some embodiments, the polymer emulsion is present in an amount of about 7.5% by weight.

In some embodiments, the polymer emulsion is present in an amount of at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 45%, or at least 50% by weight.

In some embodiments, the polymer emulsion is present in an amount of no more than 60%, no more than 55%, no more than 50%, no more than 45%, no more than 40%, no more than 35%, no more than 30%, no more than 25%, no more than 24%, no more than 23%, no more than 22%, no more than 21%, no more than 20%, no more than 19%, no more than 18%, no more than 17%, no more than 16%, no more than 15%, no more than 14%, no more than 13%, no more than 12%, no more than 11%, no more than 10%, no more than 9%, no more than 8%, no more than 7%, no more than 6%, or no more than 5% by weight.

In some embodiments, the polymer emulsion is present in an amount of from about 1% to about 50%, from about 10% to about 60%, from about 5% to about 20%, from about 5% to about 10%, from about 10% to about 20%, from about 5% to about 25%, or from about 3% to about 18% by weight. In some embodiments, the polymer emulsion is present in an amount falling within another range starting no lower than about 1% by weight and ending no higher than about 60% by weight.

In some embodiments, the polymer emulsion comprises an acrylic polymer, a styrene acrylic, vinyl acetate ethylene, a styrene-butadiene copolymer resin (SBR), a polyvinyl acetate, and/or a mixture thereof. In some embodiments, the polymer emulsion comprises acrylic copolymer, vinyl acrylic, acrylic latex, polyurethane, SBR (styrene-buladiene rubber), SBS (styrene-butadiene-styrene), polychloroprene, polyvinyl acetate, polyvinyl acetate ether, polyvinyl alcohols, parboxylic acid, synthetic Rubber, natural rubber, recycled tire rubber, LDP (low density polyethylene), EVA (ethylene vinyl acetate), nitrile latex, DuPont Elvaloy Polymer Modifier, and/or any mixture thereof.

In some embodiments, the polymer emulsion comprises acrylic latex and/or EVA latex. In some implementations, the polymer emulsion comprises a self-crosslinking acrylic latex.

In some embodiments, the polymer emulsion further comprises additional water. In some embodiments, the polymer emulsion further comprises water that is present in the polymer emulsion in an amount of at least 15%, at least 20%, at least 25%, at least 28%, at least 30%, at least 33%, at least 35%, at least 38%, at least 40%, at least 45%, at least 50%, at least 53%, at least 55%, at least 58%, at least 60%, or at least 70% by weight. In some embodiments, the polymer emulsion further comprises water that is present in the polymer emulsion in an amount of no more than 80%, no more than 70%, no more than 60%, no more than 55%, no more than 50%, no more than 45%, no more than 40%, no more than 35%, no more than 30%, or no more than 25% by weight. In some embodiments, the polymer emulsion further comprises water that is present in the polymer emulsion in an amount of from about 15% to about 50%, from about 20% to about 70%, from about 15% to about 20%, from about 25% to about 60%, from about 40% to about 80%, from about 45% to about 55%, or from about 47% to about 53% by weight. In some embodiments, the polymer emulsion further comprises water that is present in the polymer emulsion in an amount falling within another range starting no lower than about 15% by weight and ending no higher than about 80% by weight.

In some embodiments, the polymer emulsion comprises a single type of polymer emulsion. In some embodiments, the polymer emulsion comprises a plurality of types of polymer emulsion. In some embodiments, where the composition comprises a plurality of types of polymer emulsions, each type of polymer emulsion in the plurality of polymer emulsions is present in an amount (e.g., percent by weight) disclosed herein. In some such embodiments, each type of polymer emulsion in the plurality of polymer emulsions is present in the same amount (e.g., percent by weight) relative to the composition. In some such embodiments, two or more types of polymer emulsion in the plurality of polymer emulsions are present in different amounts (e.g., percent by weight) relative to the composition. In some embodiments, where the composition comprises a plurality of types of polymer emulsions, the amount of polymer emulsion present in the composition (e.g., as disclosed herein) indicates the total amount of polymer emulsion in the plurality of polymer emulsions.

By way of example, in some embodiments, the polymer emulsion comprises a first type of polymer emulsion present in an amount of about 6.9% by weight and a second type of polymer emulsion present in an amount of about 6.9% by weight, where the total amount of polymer emulsion is present in the composition in an amount of about 13.8% by weight. As another example, in some embodiments, the polymer emulsion comprises formaldehyde (e.g., less than 0.05% by weight), styrene butadiene polymer (e.g., from about 17% to about 29% by weight), vinyl acetate (e.g., less than 0.05% by weight), acrylic polymer (e.g., from about 28% to about 48% by weight), ammonia (e.g., less than 0.05% by weight), and water (e.g., from about 47% to about 53% by weight).

Advantageously, in some implementations, the inclusion of polymers in the asphalt-based sealcoat composition enhances the “wet” characteristics (e.g., stability and/or compatibility) and the “dry” characteristics (e.g., improved adhesion, abrasion, resistance, and/or other mechanical properties) of the composition. For instance, as described above, polymers can impart enhanced resistance to stretching (e.g., reduced brittleness and cracking) of the applied sealcoat, thus increasing the durability and longevity of the sealcoat. Moreover, as described above, in some implementations, the polymer emulsion comprises a plurality of types of polymer emulsion (e.g., a self-crosslinking acrylic latex and an ethylene vinyl acetate latex). In some such embodiments, the use of a mixture of polymers advantageously results in a combination of characteristics that enhances the overall performance of the asphalt-based sealcoat composition over any one individual polymer.

In some embodiments, the polymer is obtained as a component in a polymer-modified asphalt emulsion. For instance, as described above, in some implementations, a polymer emulsion is present in the obtained asphalt emulsion prior to the mixing of the asphalt-based sealcoat composition. Generally, asphalt emulsions classified with a “P” suffix refer to asphalt emulsions that have been supplemented with polymer. In another example, asphalt emulsions classified with an “L” suffix generally refer to asphalt emulsions that have been supplemented with a latex polymer. Typically, polymers are added to the asphalt emulsion to enhance the strength, adhesion, and/or durability of any asphalt-based composition including the asphalt emulsion.

In some embodiments, the asphalt emulsion is not modified with polymers, and the polymer emulsion and asphalt emulsion are individually added to the asphalt-based sealcoat composition. An example process for the preparation of asphalt-based sealcoat compositions, in which a polymer emulsion is mixed with an asphalt emulsion, is described in further detail in Example 3 and the section entitled “Preparation of asphalt-based sealcoat composition,” below. In some implementations, the use of separate polymer emulsions (e.g., not included as part of a modified asphalt emulsion) advantageously allows for greater flexibility and variety in the selection of compatible polymers with desired properties. Accordingly, in some embodiments, the polymer emulsion is introduced as a polymer latex or water-borne polymer as a component separate and independent from the asphalt.

Any polymer emulsion suitable for the preparation of asphalt-based compositions is contemplated in the amounts disclosed herein for the compositions of the present disclosure, as will be apparent to one skilled in the art.

### Clay

In some embodiments, the asphalt-based sealcoat composition comprises clay. In some embodiments, the asphalt-based sealcoat composition does not comprise clay.

In some embodiments, the clay is present in an amount of from about 1% to about 10% by weight. In some embodiments, the clay is present in an amount of from about 2% to about 8% by weight. In some embodiments, the clay is present in an amount of from about 3% to about 6% by weight. In some embodiments, the clay is present in an amount of from about 3% to about 5% by weight. In some embodiments, the clay is present in an amount of about 3.4% by weight. In some embodiments, the clay is present in an amount of about 3.7% by weight.

In some embodiments, the clay is present in an amount of at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, or at least 30% by weight. In some embodiments, the clay is present in an amount of no more than 40%, no more than 30%, no more than 25%, no more than 24%, no more than 23%, no more than 22%, no more than 21%, no more than 20%, no more than 19%, no more than 18%, no more than 17%, no more than 16%, no more than 15%, no more than 14%, no more than 13%, no more than 12%, no more than 11%, no more than 10%, no more than 9%, no more than 8%, no more than 7%, no more than 6%, or no more than 5% by weight.

In some embodiments, the clay is present in an amount of from about 1% to about 40%, from about 1% to about 10%, from about 5% to about 20%, from about 10% to about 30%, from about 2% to about 6%, from about 3% to about 5%, or from about 3% to about 12% by weight. In some embodiments, the clay is present in an amount falling within another range starting no lower than about 1% by weight and ending no higher than about 40% by weight.

In some embodiments, the clay comprises a silicate mineral. Silicate minerals generally refer to rock-forming minerals comprising silicate groups. Various groups of silicate minerals include nesosilicates, sorosilicates, cyclosilicates, inosilicates (single chain), inosilicates (double chain), phyllosilicates, and tectosilicates. In particular, phyllosilicates refer to a broad category of minerals including such clay minerals as antigorite, chrysotile, lizardite, halloysite, kaolinite, pyrophyllite, talc, illite, chlorite, vermiculite, palygorskite, biotite, fuchsite, muscovite, phlogopite, lepidolite, margarite, glauconite, sepiolite and montmorillonite, the main component of bentonite. See, e.g., Nelson, “Phyllosilicates (Micas, Chlorite, Talc, & Serpentine),” 2015, available on the Internet at tulane.edu/˜sanelson/eens211/phyllosilicates.htm, which is hereby incorporated herein by reference in its entirety.

Accordingly, in some implementations, the clay comprises phyllosilicates. In some embodiments, the clay is selected from the group consisting of bentonite clay, ball clay, fire clay, sepiolite clay, illite, montmorillonite, hawthorn clay, American colloid clay, hickory clay, Lincoln clay, and/or any mixture thereof. In some embodiments, the clay is Bentonite clay. In some embodiments, the clay is sepiolite clay.

In some embodiments, the clay is a single type of clay. In some embodiments, the clay comprises more than one type of clay (e.g., bentonite clay and sepiolite clay). In some implementations, the clay includes a mixture of clays selected from the group consisting of bentonite clay, ball clay, fire clay, sepiolite clay, illite, montmorillonite, hawthorn clay, American colloid clay, hickory clay, and/or Lincoln clay. In some embodiments, the clay comprises two or more, three or more, four or more, five or more, six or more, seven or more, eight or more, nine or more, ten or more, eleven or more, twelve or more, thirteen or more, fourteen or more, fifteen or more, or twenty or more types of clay. In some embodiments, where the composition comprises a plurality of types of clay, each type of clay in the plurality of types of clay is present in an amount (e.g., percent by weight) disclosed herein. In some such embodiments, each type of clay in the plurality of types of clay is present in the same amount (e.g., percent by weight) relative to the composition. In some such embodiments, two or more types of clay in the plurality of types of clay are present in different amounts (e.g., percent by weight) relative to the composition. In some embodiments, where the composition comprises a plurality of types of clay, the amount of clay present in the composition (e.g., as disclosed herein) indicates the total amount of clay in the plurality of types of clay.

Any clay suitable for the preparation of asphalt-based compositions is contemplated in the amounts disclosed herein for the compositions of the present disclosure, as will be apparent to one skilled in the art.

### Sand

In some embodiments, the asphalt-based sealcoat composition comprises sand. In some embodiments, the asphalt-based sealcoat composition does not comprise sand.

In some embodiments, the composition further comprises sand present in an amount of about 3% to about 25% by weight. In some embodiments, the sand is present in an amount of from about 4% to about 20% by weight. In some embodiments, the sand is present in an amount of from about 6% to about 16% by weight. In some embodiments, the sand is present in an amount of about 7% by weight. In some embodiments, the sand is present in an amount of about 6.7% by weight or about 7.3% by weight. In some embodiments, the sand is present in an amount of about 15% by weight.

In some embodiments, the sand is present in an amount of at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, or at least 30% by weight. In some embodiments, the sand is present in an amount of no more than 40%, no more than 30%, no more than 25%, no more than 24%, no more than 23%, no more than 22%, no more than 21%, no more than 20%, no more than 19%, no more than 18%, no more than 17%, no more than 16%, no more than 15%, no more than 14%, no more than 13%, no more than 12%, no more than 11%, no more than 10%, no more than 9%, no more than 8%, no more than 7%, no more than 6%, or no more than 5% by weight.

In some embodiments, the sand is present in an amount of from about 1% to about 40%, from about 2% to about 15%, from about 5% to about 20%, from about 10% to about 30%, from about 4% to about 18%, from about 30% to about 40%, or from about 3% to about 12% by weight. In some embodiments, the sand is present in an amount falling within another range starting no lower than about 1% by weight and ending no higher than about 40% by weight.

In some embodiments, the sand has a particle size mesh from about 16 to about 300. In some embodiments, the sand has a particle size mesh from about 20 to about 280. In some embodiments, the sand has a particle size mesh from about 60 to about 260. In some embodiments, the sand has a particle size mesh from about 80 to about 240. In some embodiments, the sand has a particle size mesh from about 100 to about 220. In some embodiments, the sand has a particle size mesh of about 200. In some embodiments, the sand has a particle size mesh from about 20 to about 80. In some embodiments, the sand has a particle size mesh of about 20/40.

In some embodiments, the sand has a particle size mesh of at least 10, at least 12, at least 16, at least 20, at least 30, at least 40, at least 50, at least 60, at least 70, at least 80, at least 90, at least 100, at least 150, at least 200, or at least 300. In some embodiments, the sand has a particle size mesh of no more than 400, no more than 300, no more than 200, no more than 100, no more than 70, no more than 50, or no more than 40. In some embodiments, the sand has a particle size mesh of from about 12 to about 50, from about 16 to about 70, from about 20 to about 40, from about 70 to about 300, from about 100 to about 200, or from about 150 to about 300. In some embodiments, the sand has a particle size mesh that falls within another range starting no lower than 10 and ending no higher than 400.

In some embodiments, the sand comprises a material that is similar or identical in type to a material used for one or more other components of the asphalt-based sealcoat composition (e.g., aggregate, extender, etc.). For instance, in some embodiments, the sand comprises limestone sand.

In some embodiments, the sand is a mixture of materials. For instance, in some implementations, the sand is a mixture of materials, one or more of which is similar or identical in type to a material used for one or more other components of the asphalt-based sealcoat composition (e.g., aggregate, extender, etc.). In some embodiments, the sand comprises two or more, three or more, four or more, five or more, six or more, seven or more, eight or more, nine or more, ten or more, eleven or more, twelve or more, thirteen or more, fourteen or more, fifteen or more, or twenty or more types of sand.

In some embodiments, the sand is a mixture of materials having different particle size (e.g., as determined by a particle size mesh). In some embodiments, the sand is a mixture of two or more, three or more, four or more, five or more, six or more, seven or more, eight or more, nine or more, ten or more, eleven or more, twelve or more, thirteen or more, fourteen or more, fifteen or more, or twenty or more different particle sizes. In some embodiments, the sand has a uniform particle size as determined by a particle size mesh.

In some embodiments, where the composition comprises a plurality of types (e.g., materials and/or particle sizes) of sand, each type of sand in the plurality of types of sand is present in an amount (e.g., percent by weight) disclosed herein. In some such embodiments, each type of sand in the plurality of types of sand is present in the same amount (e.g., percent by weight) relative to the composition. In some such embodiments, two or more types of sand in the plurality of types of sand are present in different amounts (e.g., percent by weight) relative to the composition. In some embodiments, where the composition comprises a plurality of types of sand, the amount of sand present in the composition (e.g., as disclosed herein) indicates the total amount of sand in the plurality of types of sand.

Any sand suitable for the preparation of asphalt-based compositions is contemplated in the amounts disclosed herein for the compositions of the present disclosure, as will be apparent to one skilled in the art.

Advantageously, in some embodiments, the sand provides anti-skid properties to the asphalt-based sealcoat composition and/or to the asphalt-based sealcoat upon application of the asphalt-based sealcoat composition. As described below with reference to Example 4, anti-skid properties can be determined using standardized testing protocols measured at a predetermined speed. For instance, ASTM standard method E274 is used to determine skid numbers SN40R and SN40S at 64 km/h (40 mph) using ribbed tires and smooth tires, respectively (see, e.g., ASTM E274/E274M-11, 2011; and Fwa, 2017, “Skid resistance determination for pavement management and wet-weather road safety,” Int J Trans Sci Tech 6 (3): 217-227, each of which is hereby incorporated herein by reference in its entirety.

Generally, measurements of pavement friction are used for pavement management purposes, such as monitoring pavement conditions and performing necessary maintenance for safety, efficiency, comfort, and durability of roads and other surfaces under various weather conditions. Skid resistance refers to the force developed when a locked tire (e.g., a tire that is prevented from rotating) slides on a paved surface. Higher skid resistance decreases the risk of vehicle skidding and hydroplaning upon surfaces, thus reducing accidents caused by, e.g., weather conditions and/or emergency braking.

While safety parameters vary between regions (e.g., states, countries, etc.), a common practice for highway agencies is to specify a minimum skid resistance for pavement management and maintenance. Accordingly, the minimum standard in some jurisdictions includes a skid number of at least 20 (e.g., 23 to 30 on highways and other high-speed surfaces). See, e.g., Fwa, 2017, “Skid resistance determination for pavement management and wet-weather road safety,” Int J Trans Sci Tech 6 (3): 217-227.

Accordingly, in some embodiments, the compositions and methods of the present disclosure provide an asphalt-based sealcoat having a skid number (SN40R) of at least about 25. In some embodiments, the asphalt-based sealcoat has a skid number SN40R of at least about 30. In some embodiments, the asphalt-based sealcoat has a skid number SN40R of at least about 35. In some embodiments, the asphalt-based sealcoat has an SN40R of at least 20, at least 21, at least 22, at least 23, at least 24, at least 25, at least 26, at least 28, at least 29, at least 30, at least 35, at least 40, at least 45, at least 50, or at least 55. In some embodiments, the asphalt-based sealcoat has an SN40R of no more than 70, no more than 60, no more than 55, no more than 50, no more than 45, no more than 40, no more than 35, no more than 30, or no more than 25. In some embodiments, the asphalt-based sealcoat has an SN40R of from about 20 to about 40, from about 25 to about 60, from about 22 to about 35, from about 30 to about 45, or from about 35 to about 65. In some embodiments, the asphalt-based sealcoat has an SN40R that falls within another range starting no lower than 20 and ending no higher than 70.

Another method of measuring pavement safety includes determining pavement friction values. Generally, higher friction values are inversely correlated with vehicle crash rates, with several studies recommending a minimum friction coefficient of 0.40 measured at 30 mph or higher. In some embodiments, friction coefficients are related to the micro-texture of paving materials and are measured using a device for microtexture (e.g., a circular track meter (CTM) and/or a dynamic friction test (DFT)). See, for example, Hall et al., “Guide for Pavement Friction,” 2006, NCHRP Project 01-43, which is hereby incorporated herein by reference in its entirety. For instance, the DFT is a portable device including a horizontal spinning disk fitted with three spring-loaded rubber slides. The disk is rotated at tangential velocities of up to 80 kph while in contact with a surface over which water is flowed. The coefficient of friction on the wet surface is continually measured as the disk slows, starting from speeds of 20-80 kph. Circular track meters, the dynamic friction test, and friction values suitable for use in the present disclosure are further described, for instance, in Wasilewska et al., “Evaluation of skid resistance using CTM, DFT and SRT-3 devices,” 2016, Transportation Research Procedia 14, 3050-3059, which is hereby incorporated herein by reference in its entirety.

Accordingly, in some embodiments, the asphalt-based sealcoat has a dynamic friction test (DFT) value of at least about 0.35. In some embodiments, the asphalt-based sealcoat has a dynamic friction test (DFT) value of at least about 0.4. In some embodiments, the asphalt-based sealcoat has a dynamic friction test (DFT) value of at least about 0.45.

In some embodiments, the asphalt-based sealcoat has a DFT value of at least about 0.20, at least about 0.25, at least about 0.30, at least about 0.35, at least about 0.40, at least about 0.45, at least about 0.50, at least about 0.55, at least about 0.60, or at least about 0.65. In some embodiments, the asphalt-based sealcoat has a DFT value of no more than 0.75, no more than 0.70, no more than 0.65, no more than 0.60, no more than 0.50, no more than 0.40, no more than 0.35, or no more than 0.30. In some embodiments, the asphalt-based sealcoat has a DFT value of from about 0.20 to about 0.50, from about 0.20 to about 0.70, from about 0.30 to about 0.55, from about 0.35 to about 0.50, or from about 0.40 to about 0.48. In some embodiments, the asphalt-based sealcoat has a DFT value that falls within another range starting no lower than 0.20 and ending no higher than 0.75.

Moreover, in some embodiments, the sand provides a coloring effect to the asphalt-based sealcoat composition. In some embodiments, for example, the sand provides a lightening effect or a darkening effect to the color of the asphalt-based sealcoat composition.

In some embodiments, the sand imparts a particular color to the asphalt-based sealcoat composition. For instance, in some implementations, the sand is a light color (e.g., white, off-white, beige, yellow, or a similar color), such that the addition of sand to the asphalt-based sealcoat composition results in a lighter colored sealcoat composition (e.g., grey and/or salt-and-pepper). Advantageously, a lighter colored sand can increase the solar reflectivity of the asphalt-based sealcoat composition and/or the asphalt-based sealcoat upon application to a surface.

### Extenders

In some embodiments, the asphalt-based sealcoat composition comprises an extender. In some embodiments, the asphalt-based sealcoat composition does not comprise an extender.

In some embodiments, the extender is present in an amount of from about 0.5% to about 40% by weight. In some embodiments, the extender is present in an amount of from about 1% to about 30% by weight. In some embodiments, the extender is present in an amount of from about 2% to about 8% by weight. In some embodiments, the extender is present in an amount of from about 3% to about 5% by weight. In some embodiments, the extender is present in an amount of about 3.1% by weight. In some embodiments, the extender is present in an amount of about 4.1% by weight. In some embodiments, the extender is present in an amount of from about 15% to about 25% by weight. In some embodiments, the extender is present in an amount of about 17.2% by weight.

In some embodiments, the extender is present in an amount of at least 0.01%, at least 0.02%, at least 0.03%, at least 0.04%, at least 0.05%, at least 0.06%, at least 0.07%, at least 0.08%, at least 0.09%, at least 0.1%, at least 0.2%, at least 0.3%, at least 0.4%, at least 0.5%, at least 0.6%, at least 0.7%, at least 0.8%, at least 0.9%, at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, or at least 25% by weight. In some embodiments, the extender is present in an amount of no more than 30%, no more than 25%, no more than 24%, no more than 23%, no more than 22%, no more than 21%, no more than 20%, no more than 19%, no more than 18%, no more than 17%, no more than 16%, no more than 15%, no more than 14%, no more than 13%, no more than 12%, no more than 11%, no more than 10%, no more than 9%, no more than 8%, no more than 7%, no more than 6%, no more than 5%, no more than 4%, no more than 3%, no more than 2%, or no more than 1% by weight.

In some embodiments, the extender is present in an amount of from about 0.1% to about 5%, from about 1% to about 5%, from about 5% to about 10%, from about 8% to about 20%, from about 0.05% to about 3%, or from about 0.5% to about 8%, by weight. In some embodiments, the extender is present in an amount falling within another range starting no lower than about 0.01% by weight and ending no higher than about 30% by weight.

In some embodiments, the extender is selected from the group consisting of marble white, granulated calcium carbonate, kaolin, kaolinite, imerys talcs, Grace SYLOWHITE™, Burgess Pigment Company kaolins, limestone dust, hydrated lime, asbestos, fuller's earth, and/or any mixture thereof. In some embodiments, the extender is marble white. In some embodiments, the extender is granulated calcium carbonate. In some embodiments, the extender is any extender suitable for the preparation of asphalt-based compositions, as will be apparent to one skilled in the art. See, for example, Kallas et al., 1962, “Mineral Fillers in Asphalt Paving Mixtures,” Highway Research Board Bulletin, 329:6-29; and Remisova, 2015, “Study of mineral filler effect on asphalt mixtures properties,” Bituminous Mixtures & Pavements VI, doi: 10.1201/b18538-9, each of which is hereby incorporated herein by reference in its entirety.

Generally, extenders are also referred to herein as fillers. Accordingly, in some embodiments, the extender includes any material suitable for use as a filler for asphalt-based compositions, as will be apparent to one skilled in the art. In some embodiments, the extender comprises a material that is similar or identical in type to a material used for one or more other components of the asphalt-based sealcoat composition (e.g., aggregate, sand, etc.). For instance, in some implementations, the extender comprises limestone dust. In some embodiments, the extender comprises diatomaceous earth.

In some embodiments, extender includes a mixture of materials. For example, in some embodiments, the extender comprises two or more types of materials selected from the group consisting of marble white, granulated calcium carbonate, kaolin, kaolinite, imerys talcs, Grace SYLOWHITE™, Burgess Pigment Company kaolins, limestone dust, hydrated lime, asbestos, and/or fuller's earth. In some embodiments, the extender comprises two or more, three or more, four or more, five or more, six or more, seven or more, eight or more, nine or more, ten or more, eleven or more, twelve or more, thirteen or more, fourteen or more, fifteen or more, or twenty or more types of materials. In some implementations, the extender includes a mixture of materials, one or more of which is similar or identical in type to a material used for one or more other components of the asphalt-based sealcoat composition (e.g., aggregate, sand, etc.).

In some embodiments, where the composition comprises a plurality of types of extenders, each type of extender in the plurality of types of extenders is present in an amount (e.g., percent by weight) disclosed herein. In some such embodiments, each type of extender in the plurality of types of extenders is present in the same amount (e.g., percent by weight) relative to the composition. In some such embodiments, two or more types of extenders in the plurality of types of extenders are present in different amounts (e.g., percent by weight) relative to the composition. In some embodiments, where the composition comprises a plurality of types of extenders, the amount of extender present in the composition (e.g., as disclosed herein) indicates the total amount of extender in the plurality of types of extenders.

Extenders can be used to supplement other components and materials in the asphalt-based sealcoat composition, thus advantageously reducing the overall cost of the composition. For instance, in some implementations, the asphalt-based sealcoat composition includes a lower proportion by weight of TiO₂ particles, where the difference in composition is made up by the inclusion of additional extenders.

Any extenders and/or fillers suitable for the preparation of asphalt-based compositions is contemplated in the amounts disclosed herein for the compositions of the present disclosure, as will be apparent to one skilled in the art.

### Fiber

In some embodiments, the asphalt-based sealcoat composition comprises fiber. In some embodiments, the asphalt-based sealcoat composition does not comprise fiber.

In some embodiments, the composition further comprises fiber present in an amount of about 0.1% to about 5% by weight. In some embodiments, the fiber is present in an amount of from about 0.3% to about 3% by weight. In some embodiments, the fiber is present in an amount of from about 0.5% to about 2% by weight. In some embodiments, the fiber is present in an amount of about 0.6% by weight.

In some embodiments, the fiber is present in an amount of at least 0.01%, at least 0.02%, at least 0.03%, at least 0.04%, at least 0.05%, at least 0.06%, at least 0.07%, at least 0.08%, at least 0.09%, at least 0.1%, at least 0.2%, at least 0.3%, at least 0.4%, at least 0.5%, at least 0.6%, at least 0.7%, at least 0.8%, at least 0.9%, at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, or at least 20% by weight. In some embodiments, the fiber is present in an amount of no more than 25%, no more than 24%, no more than 23%, no more than 22%, no more than 21%, no more than 20%, no more than 19%, no more than 18%, no more than 17%, no more than 16%, no more than 15%, no more than 14%, no more than 13%, no more than 12%, no more than 11%, no more than 10%, no more than 9%, no more than 8%, no more than 7%, no more than 6%, no more than 5%, no more than 4%, no more than 3%, no more than 2%, no more than 1%, no more than 0.9%, no more than 0.8%, no more than 0.7%, no more than 0.6%, or no more than 0.5% by weight.

In some embodiments, the fiber is present in an amount of from about 0.05% to about 5%, from about 0.1% to about 15%, from about 0.2% to about 10%, from about 0.3% to about 2%, from about 0.4% to about 1%, or from about 0.5% to about 3%, by weight. In some embodiments, the fiber is present in an amount falling within another range starting no lower than about 0.01% by weight and ending no higher than about 25% by weight.

In some embodiments, the fiber is basalt fiber, Kevlar, cellulose fiber, fiberglass, lignin fiber, polyester fiber, asbestos fiber, carbon fiber, and/or diatomite fiber. In some embodiments, the fiber is a polymeric fiber (e.g., polyethylene-based fiber and/or polypropylene-based fiber). For instance, in some embodiments, the fiber is any fiber suitable for the preparation of asphalt-based compositions, as will be apparent to one skilled in the art. See, for example, Guo et al., “Evaluation of the Effect of Fiber Type, Length, and Content on Asphalt Properties and Asphalt Mixture Performance,” Materials (Basel), 2020; 13 (7): 1556, doi: 10.3390/ma13071556, which is hereby incorporated herein by reference in its entirety.

In some embodiments, the fiber is recycled paper or fabric.

In some embodiments, the fiber includes a mixture of materials. For instance, in some embodiments, the fiber comprises two or more types of materials selected from the group consisting of basalt fiber, Kevlar, cellulose fiber, fiberglass, lignin fiber, polyester fiber, asbestos fiber, carbon fiber, and/or diatomite fiber. In some embodiments, the fiber comprises two or more, three or more, four or more, five or more, six or more, seven or more, eight or more, nine or more, ten or more, eleven or more, twelve or more, thirteen or more, fourteen or more, fifteen or more, or twenty or more types of materials.

In some embodiments, where the composition comprises a plurality of types of fiber, each type of fiber in the plurality of types of fiber is present in an amount (e.g., percent by weight) disclosed herein. In some such embodiments, each type of fiber in the plurality of types of fiber is present in the same amount (e.g., percent by weight) relative to the composition. In some such embodiments, two or more types of fiber in the plurality of types of fiber are present in different amounts (e.g., percent by weight) relative to the composition. In some embodiments, where the composition comprises a plurality of types of fiber, the amount of fiber present in the composition (e.g., as disclosed herein) indicates the total amount of fiber in the plurality of types of fiber.

Advantageously, as described above, the asphalt-based sealcoat composition has a thick and/or creamy consistency that is due at least in part to the fiber. The fiber, in some implementations, increases the stability of the composition during storage and transportation, as well as the ease and efficacy with which the asphalt-based sealcoat compositions can be applied to a surface. In particular, fibers in solution can impart non-Newtonian properties to the product, allowing the composition to flow like a liquid under stress while returning to a solid-like state once force is released. Thus, in some implementations, fiber imparts “dry” properties (e.g., resistance to stretching, formation of a mat-like structure in the sealcoat to improve durability, etc.) as well as “wet” properties to the composition. As such, in some implementations, the asphalt-based sealcoat compositions are stable during storage (e.g., in a vessel such as a can), during application (e.g., via pumping, squeegeeing, or spraying), and after application (e.g., while drying on a surface). In other words, the asphalt-based sealcoat compositions are capable of behaving like a solid under low shear or minimal external forces (e.g., such that it will not run off the road into the sewers) and like a liquid under some mechanical force, allowing it to flow, e.g., to be sprayed or pumped, during application. In some embodiments, the improved stability and applicability is due in part to the inclusion of fiber in the asphalt-based sealcoat compositions.

### Aggregates

In some embodiments, the asphalt-based sealcoat composition comprises an aggregate. In some embodiments, the asphalt-based sealcoat composition does not comprise an aggregate.

In some embodiments, the composition further comprises an aggregate present in an amount of about 0.1% to about 25% by weight. In some embodiments, the aggregate is present in an amount of from about 0.5% to about 20% by weight. In some embodiments, the aggregate is present in an amount of from about 0.9% to about 15% by weight. In some embodiments, the aggregate is present in an amount of about 7.3% by weight. In some embodiments, the aggregate is present in an amount of about 7% by weight. In some embodiments, the aggregate is present in an amount of about 6.7% by weight.

In some embodiments, the aggregate is present in an amount of at least 0.01%, at least 0.02%, at least 0.03%, at least 0.04%, at least 0.05%, at least 0.06%, at least 0.07%, at least 0.08%, at least 0.09%, at least 0.1%, at least 0.2%, at least 0.3%, at least 0.4%, at least 0.5%, at least 0.6%, at least 0.7%, at least 0.8%, at least 0.9%, at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 35%, at least 40%, or at least 50% by weight. In some embodiments, the aggregate is present in an amount of no more than 60%, no more than 50%, no more than 40%, no more than 30%, no more than 25%, no more than 24%, no more than 23%, no more than 22%, no more than 21%, no more than 20%, no more than 19%, no more than 18%, no more than 17%, no more than 16%, no more than 15%, no more than 14%, no more than 13%, no more than 12%, no more than 11%, no more than 10%, no more than 9%, no more than 8%, no more than 7%, no more than 6%, or no more than 5% by weight.

In some embodiments, the aggregate is present in an amount of from about 0.1% to about 5%, from about 1% to about 10%, from about 5% to about 15%, from about 3% to about 20%, from about 0.05% to about 25%, or from about 10% to about 60%, by weight. In some embodiments, the aggregate is present in an amount falling within another range starting no lower than about 0.01% by weight and ending no higher than about 60% by weight.

In some embodiments, the aggregate is selected from the group consisting of slate, baghouse fines (rock dust), fly ash, quartz sand, silica sand, calcium carbonite, clay, paper fiber, fiberglass fiber, limestone aggregate, copper slag, iron slag, steel slag, aluminum oxide, recycled roofing shingles, ground leather, ground rubber, nylon flock, plastic flock, glass beads, granite aggregate, ground tire rubber, ground up tennis balls, recycled cardboard, recycled glass, wood chips, wood fiber, walnut shells, apricot shells, pecan shells, corn cobs, rice hulls, scrabbled stone, pumice, basaltic aggregate, perlite, vermiculite, marble white, melamine, urea, calcinated bauxite, and/or any mixture thereof. In some embodiments, the aggregate is slate. In some embodiments, the aggregate is limestone aggregate. For instance, in some embodiments, the aggregate is any aggregate suitable for the preparation of asphalt-based compositions, as will be apparent to one skilled in the art. See, for example, Asphalt Paving Association of Iowa, “Asphalt Paving Design Guide,” available on the Internet at apai.net/Files/content/DesignGuide/AsphaltCompositeSmFst.pdf; Composition Materials Co., Inc., “Fillers, Fibers, and Powders,” available on the Internet at compomat.com/additional-fillers-extenders/; Composition Materials Co., Inc., “Aluminum Oxide Abrasive,” available on the Internet at compomat.com/aluminum-oxide-abrasive/; Composition Materials Co., Inc., “Bio-Based Fillers,” available on the Internet at compomat.com/bio-based-fillers/; and Composition Materials Co., Inc., “Recycled Fillers,” available on the Internet at compomat.com/plastic-media-fillers/.

In some embodiments, the aggregate comprises a material that is similar or identical in type to a material used for one or more other components of the asphalt-based sealcoat composition (e.g., extender, sand, etc.). For instance, in some embodiments, the aggregate comprises limestone aggregate.

In some embodiments, the aggregate includes a mixture of materials. For example, in some embodiments, the aggregate comprises two or more types of materials selected from the group consisting of slate, baghouse fines (rock dust), fly ash, quartz sand, silica sand, calcium carbonite, clay, paper fiber, fiberglass fiber, limestone aggregate, copper slag, iron slag, steel slag, aluminum oxide, recycled roofing shingles, ground leather, ground rubber, nylon flock, plastic flock, glass beads, granite aggregate, ground tire rubber, ground up tennis balls, recycled cardboard, recycled glass, wood chips, wood fiber, walnut shells, apricot shells, pecan shells, corn cobs, rice hulls, scrabbled stone, pumice, basaltic aggregate, perlite, vermiculite, marble white, melamine, urea, calcinated bauxite, and/or any mixture thereof. In some implementations, the aggregate is a mixture of materials, one or more of which is similar or identical in type to a material used for one or more other components of the asphalt-based sealcoat composition (e.g., extender, sand, etc.). In some embodiments, the aggregate comprises two or more, three or more, four or more, five or more, six or more, seven or more, eight or more, nine or more, ten or more, eleven or more, twelve or more, thirteen or more, fourteen or more, fifteen or more, or twenty or more types of aggregate.

In some embodiments, where the composition comprises a plurality of types of aggregate, each type of aggregate in the plurality of types of aggregate is present in an amount (e.g., percent by weight) disclosed herein. In some such embodiments, each type of aggregate in the plurality of types of aggregate is present in the same amount (e.g., percent by weight) relative to the composition. In some such embodiments, two or more types of aggregate in the plurality of types of aggregate are present in different amounts (e.g., percent by weight) relative to the composition. In some embodiments, where the composition comprises a plurality of types of aggregate, the amount of aggregate present in the composition (e.g., as disclosed herein) indicates the total amount of aggregate in the plurality of types of aggregate.

Advantageously, in some embodiments, the aggregate includes a material that has anti-skid properties. For example, in some embodiments, the aggregate includes a material that imparts improved anti-skid properties to the asphalt-based sealcoat. As an example, calcinated bauxite can be used in asphalt-based high friction surface treatments (HFST) for problematic turns and inclines. Additional materials that impart anti-skid properties to the asphalt-based sealcoat are disclosed further herein (see, e.g., the section entitled, “Sand,” above).

In some embodiments, the aggregate is selected based on an ability to increase or decrease the hardness of the asphalt-based sealcoat. For instance, harder aggregates will impart increased hardness to the asphalt-based sealcoat.

### Biocide

In some embodiments, the asphalt-based sealcoat composition comprises biocide. In some embodiments, the asphalt-based sealcoat composition does not comprise a biocide.

In some embodiments, the biocide is present in an amount of from about 0.01% to about 5% by weight. In some embodiments, the biocide is present in an amount of from about 0.1% to about 2% by weight. In some embodiments, the biocide is present in an amount of about 0.3% by weight. In some embodiments, the biocide is present in an amount of about 0.2% by weight.

In some embodiments, the biocide is present in an amount of at least 0.01%, at least 0.02%, at least 0.03%, at least 0.04%, at least 0.05%, at least 0.06%, at least 0.07%, at least 0.08%, at least 0.09%, at least 0.1%, at least 0.2%, at least 0.3%, at least 0.4%, at least 0.5%, at least 0.6%, at least 0.7%, at least 0.8%, at least 0.9%, at least 1%, at least 2%, at least 3%, at least 4%, at least 5%, at least 6%, at least 7%, at least 8%, at least 9%, or at least 10% by weight. In some embodiments, the biocide is present in an amount of no more than 15%, no more than 10%, no more than 5%, no more than 4%, no more than 3%, no more than 2%, no more than 1%, no more than 0.9%, no more than 0.8%, no more than 0.7%, no more than 0.6%, no more than 0.5%, no more than 0.4%, no more than 0.3%, no more than 0.2%, or no more than 0.1% by weight.

In some embodiments, the biocide is present in an amount of from about 0.05% to about 5%, from about 0.1% to about 10%, from about 0.2% to about 1%, from about 0.1% to about 2%, from about 0.01% to about 15%, or from about 0.1% to about 0.5%, by weight. In some embodiments, the biocide is present in an amount falling within another range starting no lower than about 0.01% by weight and ending no higher than about 15% by weight.

In some embodiments, the biocide comprises a single type of biocide. In some embodiments, the biocide comprises a plurality of types of biocide. In some embodiments, where the composition comprises a plurality of types of biocide, each type of biocide in the plurality of types of biocide is present in an amount (e.g., percent by weight) disclosed herein. In some such embodiments, each type of biocide in the plurality of types of biocide is present in the same amount (e.g., percent by weight) relative to the composition. In some such embodiments, two or more types of biocide in the plurality of types of biocide are present in different amounts (e.g., percent by weight) relative to the composition. In some embodiments, where the composition comprises a plurality of types of biocide, the amount of biocide present in the composition (e.g., as disclosed herein) indicates the total amount of biocide in the plurality of types of biocide.

### Dispersants

In some embodiments, the asphalt-based sealcoat composition comprises a dispersant. In some embodiments, the asphalt-based sealcoat composition does not comprise a dispersant.

In some embodiments, the dispersant is present in an amount of about 0.01% to about 10% by weight. In some embodiments, the dispersant is present in an amount of from about 0.03% to about 3% by weight. In some embodiments, the dispersant is present in an amount of from about 0.05% to about 1% by weight. In some embodiments, the dispersant is present in an amount of about 0.07% by weight. In some embodiments, the dispersant is present in an amount of about 0.2% by weight.

In some embodiments, the dispersant is present in an amount of at least 0.001%, at least 0.002%, at least 0.003%, at least 0.004%, at least 0.005%, at least 0.006%, at least 0.007%, at least 0.008%, at least 0.009%, at least 0.01%, at least 0.02%, at least 0.03%, at least 0.04%, at least 0.05%, at least 0.06%, at least 0.07%, at least 0.08%, at least 0.09%, at least 0.1%, at least 0.2%, at least 0.3%, at least 0.4%, at least 0.5%, at least 0.6%, at least 0.7%, at least 0.8%, at least 0.9%, at least 1%, at least 2%, at least 3%, at least 4%, at least 5%, at least 6%, at least 7%, at least 8%, at least 9%, at least 10%, at least 11%, at least 12%, at least 13%, at least 14%, or at least 15% by weight.

In some embodiments, the dispersant is present in an amount of no more than 20%, no more than 15%, no more than 10%, no more than 9%, no more than 8%, no more than 7%, no more than 6%, no more than 5%, no more than 4%, no more than 3%, no more than 2%, no more than 1%, no more than 0.9%, no more than 0.8%, no more than 0.7%, no more than 0.6%, no more than 0.5%, no more than 0.4%, no more than 0.3%, no more than 0.2%, no more than 0.1%, no more than 0.09%, no more than 0.08%, no more than 0.07%, no more than 0.06%, no more than 0.05%, no more than 0.04%, no more than 0.03%, no more than 0.02%, or no more than 0.01% by weight.

In some embodiments, the dispersant is present in an amount of from about 0.05% to about 5%, from about 0.1% to about 15%, from about 0.2% to about 10%, from about 0.001% to about 2%, from about 0.01% to about 1%, from about 0.05 to about 0.1, from about 0.03 to about 0.5, or from about 0.5% to about 3% by weight. In some embodiments, the dispersant is present in an amount falling within another range starting no lower than about 0.001% by weight and ending no higher than about 20% by weight.

In some embodiments, the dispersant comprises a single type of dispersant. In some embodiments, the dispersant comprises a plurality of types of dispersant. In some embodiments, where the composition comprises a plurality of types of dispersant, each type of dispersant in the plurality of types of dispersant is present in an amount (e.g., percent by weight) disclosed herein. In some such embodiments, each type of dispersant in the plurality of types of dispersant is present in the same amount (e.g., percent by weight) relative to the composition. In some such embodiments, two or more types of dispersant in the plurality of types of dispersant are present in different amounts (e.g., percent by weight) relative to the composition. In some embodiments, where the composition comprises a plurality of types of dispersant, the amount of dispersant present in the composition (e.g., as disclosed herein) indicates the total amount of dispersant in the plurality of types of dispersant.

In some embodiments, the dispersant is used to disperse pigments in the composition (e.g., an infrared-reflective pigment as described elsewhere herein; see, e.g., the section entitled “Reflectance of asphalt-based sealcoat composition,” below). In some embodiments, the dispersant is used to disperse TiO₂ in the composition. In some embodiments, the dispersant is mixed with pigment (e.g., an IR-reflective pigment) to disperse (e.g., homogenize) the pigment prior to adding the dispersant and the pigment to the composition. In some embodiments, the dispersant is mixed with TiO₂ particles to disperse (e.g., homogenize) the TiO₂ particles prior to adding the dispersant and the TiO₂ particles to the composition.

In some embodiments, the dispersant contributes to the stability of the composition. For instance, in some embodiments, a dispersant is used to stabilize an asphalt emulsion. In some implementations, stabilization advantageously allows for a wider variety of asphalt sources, improved product stability, and better control of drying and reactivity. In some embodiments, the dispersant contributes to the pH stability of the composition.

In some embodiments, the dispersant is selected from the group consisting of polyacrylic acid, copolymers, polyurethanes, polyacrylates, star-shaped dispersing polymers, block copolymers, controlled free radical polymerization (CFRP), and amines. In some embodiments, the dispersant is 2-amino-2-methyl-1-propanol. For instance, in some embodiments, the dispersant is any dispersant suitable for the preparation of asphalt-based compositions, as will be apparent to one skilled in the art.

In some embodiments, the dispersant is selected depending on the identity of the pigment (e.g., an IR-reflective pigment) that is to be dispersed throughout the composition. For instance, a recommended type of dispersant can depend on the surface characteristics of the desired pigment. In some embodiments, different dispersants can exhibit different levels of effectiveness for different pigments. Accordingly, in some embodiments, the dispersant contains phenyl or naphthyl groups, acidic groups (e.g., phosphate, carboxy, and/or sulfate), and/or nitrogen.

### Plasticizer

In some embodiments, the asphalt-based sealcoat composition comprises a plasticizer. In some embodiments, the asphalt-based sealcoat composition does not comprise a plasticizer.

In some embodiments, the plasticizer is present in an amount of about 0.1% to about 20% by weight. In some embodiments, the plasticizer is present in an amount of from about 0.5% to about 10% by weight. In some embodiments, the plasticizer is present in an amount of from about 1% to about 5% by weight. In some embodiments, the plasticizer is present in an amount of about 1.5% by weight.

In some embodiments, the plasticizer is present in an amount of at least 0.01%, at least 0.02%, at least 0.03%, at least 0.04%, at least 0.05%, at least 0.06%, at least 0.07%, at least 0.08%, at least 0.09%, at least 0.1%, at least 0.2%, at least 0.3%, at least 0.4%, at least 0.5%, at least 0.6%, at least 0.7%, at least 0.8%, at least 0.9%, at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, or at least 20% by weight. In some embodiments, the plasticizer is present in an amount of no more than 25%, no more than 24%, no more than 23%, no more than 22%, no more than 21%, no more than 20%, no more than 19%, no more than 18%, no more than 17%, no more than 16%, no more than 15%, no more than 14%, no more than 13%, no more than 12%, no more than 11%, no more than 10%, no more than 9%, no more than 8%, no more than 7%, no more than 6%, no more than 5%, no more than 4%, no more than 3%, no more than 2%, no more than 1%, no more than 0.9%, no more than 0.8%, no more than 0.7%, no more than 0.6%, or no more than 0.5% by weight.

In some embodiments, the plasticizer is present in an amount of from about 0.05% to about 5%, from about 0.1% to about 15%, from about 0.2% to about 10%, from about 0.3% to about 2%, from about 0.4% to about 1%, or from about 0.5% to about 3%, by weight. In some embodiments, the plasticizer is present in an amount falling within another range starting no lower than about 0.01% by weight and ending no higher than about 25% by weight.

In some embodiments, the plasticizer is selected from the group consisting of low molecular weight ortho phthalates, high molecular weight ortho phthalates, trimellitates, adipates, sebacates, glycerol triacetate, alkyl citrates, azelates, dibenzoates, terephthalates, gluterates, organophosphates, polycarboxylate ether, polycarboxylate, sulfonated naphthalene condensate, and sulfonated melamine formaldehyde. In some embodiments, the plasticizer is a low volatile organic compound (VOC) plasticizer.

In some embodiments, the plasticizer is any plasticizer suitable for the preparation of asphalt-based compositions, as will be apparent to one skilled in the art. For example, low molecular weight ortho phthalates include, but are not limited to, Diisobutyl phthalate (DIBP), Di-n-butyl phthalate (DBP), Butyl benzyl phthalate (BBzP), and/or Bis(2-ethylhexyl) phthalate (DEHP). High molecular weight ortho phthalates include, but are not limited to, Diisononyl phthalate (DINP), Bis(2-propylheptyl) phthalate (DPHP), Diisodecyl phthalate (DIDP), Diisoundecyl phthalate (DIUP), and/or Ditridecyl phthalate (DTDP). Trimellitates include, but are not limited to. Tri-(2-ethylhexyl)trimellitate (TEHTM)(TOTM), Tri-(isononyl)trimellitate (TINTM), Tri-(isodecyl)trimellitate (TIDTM), and/or Tri-(isotridecyl)trimellitate (TITDTM).

In some embodiments, the plasticizer comprises a single type of plasticizer. In some embodiments, the plasticizer comprises a plurality of types of plasticizer. In some embodiments, where the composition comprises a plurality of types of plasticizer, each type of plasticizer in the plurality of types of plasticizer is present in an amount (e.g., percent by weight) disclosed herein. In some such embodiments, each type of plasticizer in the plurality of types of plasticizer is present in the same amount (e.g., percent by weight) relative to the composition. In some such embodiments, two or more types of plasticizer in the plurality of types of plasticizer are present in different amounts (e.g., percent by weight) relative to the composition. In some embodiments, where the composition comprises a plurality of types of plasticizer, the amount of plasticizer present in the composition (e.g., as disclosed herein) indicates the total amount of plasticizer in the plurality of types of plasticizer.

In some embodiments, for example, plasticizers are used to promote softness, plasticity, and/or flexibility, and to reduce viscosity, friction, and/or brittleness in the asphalt-based sealcoat composition. In some implementations, plasticizers reduce the glass transition temperature of the asphalt-based sealcoat composition. Lower glass transition temperatures are beneficial in that they result in a more resilient, rubbery product with increased resistance to mechanical stress (e.g., cracking, elongation, fracture, and/or general film failure). This advantageously improves the ease with which the asphalt-based sealcoat composition forms a consistent film during drying.

### Dirt-Resistance Additives

In some embodiments, the asphalt-based sealcoat composition further comprises a dirt-resistance additive. In some embodiments, the asphalt-based sealcoat composition does not comprise a dirt-resistance additive.

In some embodiments, the dirt-resistance additive is present in an amount of at least 0.01%, at least 0.02%, at least 0.03%, at least 0.04%, at least 0.05%, at least 0.06%, at least 0.07%, at least 0.08%, at least 0.09%, at least 0.1%, at least 0.2%, at least 0.3%, at least 0.4%, at least 0.5%, at least 0.6%, at least 0.7%, at least 0.8%, at least 0.9%, at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, or at least 20% by weight. In some embodiments, the dirt-resistance additive is present in an amount of no more than 25%, no more than 24%, no more than 23%, no more than 22%, no more than 21%, no more than 20%, no more than 19%, no more than 18%, no more than 17%, no more than 16%, no more than 15%, no more than 14%, no more than 13%, no more than 12%, no more than 11%, no more than 10%, no more than 9%, no more than 8%, no more than 7%, no more than 6%, no more than 5%, no more than 4%, no more than 3%, no more than 2%, no more than 1%, no more than 0.9%, no more than 0.8%, no more than 0.7%, no more than 0.6%, or no more than 0.5% by weight.

In some embodiments, the dirt-resistance additive is present in an amount of from about 0.05% to about 5%, from about 0.1% to about 15%, from about 0.2% to about 10%, from about 0.3% to about 2%, from about 0.4% to about 1%, or from about 0.5% to about 3%, by weight. In some embodiments, the dirt-resistance additive is present in an amount falling within another range starting no lower than about 0.01% by weight and ending no higher than about 25% by weight.

In some embodiments, the dirt-resistance additive is colloidal silica. In some embodiments, the dirt-resistance additive is methyl-o-benzoyl benzoate (MBB). Suitable embodiments for dirt-resistance additives contemplated for use in the present disclosure are further disclosed in, e.g., U.S. Patent Application No. U.S. Ser. No. 16/910,743, filed Jun. 24, 2020, which is hereby incorporated herein by reference in its entirety.

The compositions and various components disclosed herein are not intended to be limiting. For example, any of the compositions provided herein may be substituted, modified, added, subtracted, and/or combined with any suitable component of asphalt-based sealcoat compositions, as will be apparent to one skilled in the art. Additional embodiments for asphalt-based sealcoat compositions and components of the same are contemplated, as further described in International Application No. PCT/US2018/066431, filed 19 Dec. 2018, and U.S. Provisional Patent Application No. 62/608,881, filed 21 Dec. 2017, each of which is hereby incorporated herein by reference in its entirety.

### IV. Reflectance of Asphalt-Based Sealcoat Composition

In one aspect, the present disclosure relates to an asphalt-based sealcoat composition that is highly solar reflective. In some embodiments, the asphalt-based sealcoat has a Solar Reflectivity number (SR #) of at least about 0.10. In some embodiments, the asphalt-based sealcoat has a Solar Reflectivity number (SR #) of at least about 0.15. In some embodiments, the asphalt-based sealcoat has a SR # of at least about 0.20. In some embodiments, the asphalt-based sealcoat has a SR # of at least about 0.30. In some embodiments, the asphalt-based sealcoat has a SR # of at least about 0.33. In some embodiments, the asphalt-based sealcoat has a SR # of at least about 0.35.

In some embodiments, the asphalt-based sealcoat has a SR # of at least about 0.10, at least about 0.11, at least about 0.12, at least about 0.13, at least about 0.14, at least about 0.15, at least about 0.16, at least about 0.17, at least about 0.18, at least about 0.19, at least about 0.20, at least about 0.21, at least about 0.22, at least about 0.23, at least about 0.24, at least about 0.25, at least about 0.26, at least about 0.27, at least about 0.28, at least about 0.29, at least about 0.30, at least about 0.31, at least about 0.32, at least about 0.33, at least about 0.34, at least about 0.35, at least about 0.36, at least about 0.37, at least about 0.38, at least about 0.39, at least about 0.40, at least about 0.41, at least about 0.42, at least about 0.43, at least about 0.44, at least about 0.45, at least about 0.46, at least about 0.47, at least about 0.48, at least about 0.49, at least about 0.50, at least about 0.55, at least about 0.60, at least about 0.65, or at least about 0.70.

In some embodiments, the asphalt-based sealcoat has a SR # of from about 0.20 to about 0.60. In some embodiments, the asphalt-based sealcoat has a SR # of from about 0.10 to about 0.45, from about 0.20 to about 0.40, from about 0.25 to about 0.38, from about 0.30 to about 0.36, from about 0.30 to about 0.50, from about 0.35 to about 0.45, from about 0.42 to about 0.50, or from about 0.45 to about 0.65. In some embodiments, the asphalt-based sealcoat has a SR # that falls within another range starting no lower than 0.10 and ending no higher than 0.70.

In some embodiments, the asphalt-based sealcoat has Solar Reflective Index (SRI #) of at least about 10. In some embodiments, the asphalt-based sealcoat has an SRI # of at least about 20. In some embodiments, the asphalt-based sealcoat has an SRI # of at least about 30. In some embodiments, the asphalt-based sealcoat has an SRI # of at least about 33. In some embodiments, the asphalt-based sealcoat has an SRI # of about 35.

In some embodiments, the asphalt-based sealcoat has a SRI # of at least about 10, at least about 11, at least about 12, at least about 13, at least about 14, at least about 15, at least about 16, at least about 17, at least about 18, at least about 19, at least about 20, at least about 21, at least about 22, at least about 23, at least about 24, at least about 25, at least about 26, at least about 27, at least about 28, at least about 29, at least about 30, at least about 31, at least about 32, at least about 33, at least about 34, at least about 35, at least about 36, at least about 37, at least about 38, at least about 39, at least about 40, at least about 41, at least about 42, at least about 43, at least about 44, at least about 45, at least about 46, at least about 47, at least about 48, at least about 49, at least about 50, at least about 55, at least about 60, at least about 65, or at least about 70.

In some embodiments, the asphalt-based sealcoat has an SRI # of from about 20 to about 60. In some embodiments, the asphalt-based sealcoat has an SRI # of from about 10 to about 45, from about 20 to about 40, from about 25 to about 38, from about 30 to about 36, from about 30 to about 50, from about 35 to about 45, from about 42 to about 50, or from about 45 to about 65. In some embodiments, the asphalt-based sealcoat has an SRI # that falls within another range starting no lower than 10 and ending no higher than 70.

In some embodiments, the asphalt-based sealcoat has an emissivity of at least about 0.70. In some embodiments, the asphalt-based sealcoat has an emissivity of at least about 0.80. In some embodiments, the asphalt-based sealcoat has an emissivity of at least about 0.90. In some embodiments, the asphalt-based sealcoat has an emissivity of at least about 0.92. In some embodiments, the asphalt-based sealcoat has an emissivity of about 0.92. In some embodiments, the asphalt-based sealcoat has an emissivity of from about 0.70 to about 0.99.

In some embodiments, the asphalt-based sealcoat composition reduces surface temperatures of asphalt treated with the asphalt-based sealcoat composition compared to asphalt not treated with asphalt-based sealcoat composition.

In some embodiments, the reflectance of the asphalt-based sealcoat composition is determined using a pyrometer at different times of day over a two-month period according to ASTM E1918-16, Standard Test Method for Measuring Solar Reflectance of Horizontal and Low-Sloped Surfaces in the Field, ASTM International, West Conshohocken, PA, 2016, www.astm.org. Due to the varying position and angle of the sun during these times, this allows measurements of multiple different areas within test sections of the asphalt-based sealcoat composition.

In some embodiments, the reflectance and thermal emissivity of the asphalt-based sealcoat composition is determined by subjecting a core of a section of the composition to ASTM C 1549 (ASTM C1549-16, “Standard Test Method for Determination of Solar Reflectance Near Ambient Temperature Using a Portable Solar Reflectometer,” ASTM International, West Conshohocken, PA, 2016, www.astm.org) and ASTM C1371 (ASTM C1371-15, “Standard Test Method for Determination of Emittance of Materials Near Room Temperature Using Portable Emissometers,” ASTM International, West Conshohocken, PA, 2015, www.astm.org), respectively. SRI values can then be calculated according to ASTM E1980-11 (“Standard Practice for Calculating Solar Reflectance Index of Horizontal and Low-Sloped Opaque Surfaces,” ASTM International, West Conshohocken, PA, 2001, www.astm.org).

In some implementations, the asphalt-based sealcoat composition has an SRI # that satisfies LEED requirements while using low amounts of TiO₂ particles. Further details on LEED requirements are disclosed in, e.g., “LEED ND: Plan v4-LEED v4 Heat island reduction,” available on the Internet at usgbc.org/credits/neighborhood-development-plan-neighborhood-development/v4-draft/gibc-9, which is hereby incorporated herein by reference in its entirety. As described above, the reduction in the amount of TiO₂ particles can be supplemented by low-cost materials, such as extenders and/or fillers.

In some such implementations, the asphalt-based sealcoat compositions advantageously reduce the cost of sealcoat compositions while maintaining high solar reflectivity and thus reducing surface temperatures of asphalt treated with the asphalt-based sealcoat compositions compared to asphalt not treated with asphalt-based sealcoat compositions. Accordingly, in some implementations, the asphalt-based sealcoat composition includes TiO₂ particles present in an amount of no more than 30% by weight and has an SRI # of at least 30. In some implementations, the asphalt-based sealcoat composition includes TiO₂ particles present in an amount of no more than 20% by weight and has an SRI # of at least 33. In some implementations, the asphalt-based sealcoat composition includes TiO₂ particles present in an amount of no more than 15% by weight and has an SRI # of at least 35.

In some embodiments, the asphalt-based sealcoat composition includes TiO₂ particles present in an amount of no more than 35%, no more than 30%, no more than 25%, no more than 20%, or no more than 15% by weight and has an SRI # of at least 23, at least 25, at least 30, at least 33, or at least 35. In an example embodiment, the asphalt-based sealcoat composition includes TiO₂ particles present in an amount of about 10% by weight and has an SRI # of about 38.

In some embodiments, the asphalt-based sealcoat composition further includes a pigment. In some embodiments, the pigment is present in an amount of from about 0.01% to about 5% by weight. In some embodiments, the pigment is present in an amount of from about 0.05% to about 1% by weight. In some embodiments, the pigment is present in an amount of from about 0.1% to about 0.5% by weight.

In some embodiments, the pigment is present in an amount of at least 0.01%, at least 0.02%, at least 0.03%, at least 0.04%, at least 0.05%, at least 0.06%, at least 0.07%, at least 0.08%, at least 0.09%, at least 0.1%, at least 0.2%, at least 0.3%, at least 0.4%, at least 0.5%, at least 0.6%, at least 0.7%, at least 0.8%, at least 0.9%, at least 1%, at least 2%, at least 3%, at least 4%, at least 5%, at least 6%, at least 7%, at least 8%, at least 9%, or at least 10% by weight. In some embodiments, the pigment is present in an amount of no more than 15%, no more than 14%, no more than 13%, no more than 12%, no more than 11%, no more than 10%, no more than 9%, no more than 8%, no more than 7%, no more than 6%, no more than 5%, no more than 4%, no more than 3%, no more than 2%, no more than 1%, no more than 0.9%, no more than 0.8%, no more than 0.7%, no more than 0.6%, or no more than 0.5% by weight. In some embodiments, the pigment is present in an amount of from about 0.05% to about 5%, from about 1% to about 5%, from about 0.2% to about 10%, from about 0.3% to about 2%, from about 0.4% to about 1%, or from about 0.5% to about 3%, by weight. In some embodiments, the pigment is present in an amount falling within another range starting no lower than about 0.01% by weight and ending no higher than about 15% by weight.

Generally, pigments refer to inorganic or organic colorants with little to no solubility in most application mediums (e.g., compositions). For instance, in some embodiments, organic pigments comprise synthetic materials based on carbon and can be derived from petrochemicals. Typically, organic pigments are not stable at elevated temperatures and have partial solubility in strong solvents but are not soluble in water. In some embodiments, inorganic pigments comprise metal salts and oxides (e.g., natural and/or synthetic), are generally stable at elevated temperatures, and do not dissolve in solvents. Inorganic pigments have generally stable chemical structures and thus, in some embodiments, are characterized by better weatherability, dispersibility and opacity than organic pigments, albeit with lower chromaticity and tinctorial strength. Accordingly, in some embodiments, the pigment is organic or inorganic. In some embodiments, the pigment is opaque or transparent. In some embodiments, the pigment is an inorganic, opaque pigment. In some embodiments, the pigment is an organic, transparent pigment. In some embodiments, the pigment is an inorganic, transparent pigment. In some embodiments, the pigment is an organic, opaque pigment.

In some embodiments, the pigment is infrared (IR) or near-infrared (NIR) reflective. In some embodiments, the pigment is a dark-colored pigment. Accordingly, in some implementations, the pigment is an infrared reflective, dark pigment. Darkly pigmented asphalt-based sealcoat compositions may be desirable for various applications where paving is typically dark, such as roads, parking lots, driveways, and/or roofing. As such, dark pigments can provide greater functionality to asphalt-based sealcoat compositions by facilitating visual compatibility and consistency upon application to existing paved surfaces.

Advantageously, dark pigments have been reported to exhibit high infrared or near infrared reflectance in the electromagnetic spectrum. For example, in some embodiments, products containing IR-reflective dark pigments have been reported to exhibit IR reflectance on a scale comparable to that produced by white-pigmented products. See, e.g., Miller et al., 2004, “Special Infrared Reflective Pigments Make a Dark Roof Reflect Almost Like a White Roof,” in Thermal Performance of the Exterior Envelopes of Buildings, IX, proceedings of ASHRAE THERM VIII, Clearwater, FL, which is hereby incorporated herein by reference in its entirety.

Accordingly, the presently disclosed compositions and methods include dark-pigmented asphalt-based sealcoat compositions that maintain high solar reflectivity and can also be applied in situations where a dark color is preferred. For example, as described above, it may be desirable to maintain a consistent color or shading when applying sealcoat compositions to paved surfaces such as roads, playgrounds, parking lots, and/or driveways.

In some embodiments, the pigment is selected from the group consisting of red iron oxides, yellow iron oxides, phthalocyanine blue, perelyene black, chromic oxides (Cr₂O₃), ferric oxides (Fe₂O₃), white titanates, yellow titanates, green titanates, brown titanates, brown iron oxides, black iron oxides, miceous iron oxides, cadmium orange, cadmium yellow, and chromium iron oxides. In some embodiments, the pigment is Chromium Green-Black Hematite. In some embodiments, the pigment includes spherical particles. Alternately or additionally, in some embodiments, the pigment includes lamellar (e.g., plate-like) particles. Generally, lamellar particles can be used to form lamellar structures in which the particles are positioned parallel but offset to each other. Without being limited to any one theory of operation, the alternating layers within such lamellar structures can impart additional barrier properties against UV and/or corrosion. For instance, in some implementations, the pigment is selected from the group consisting of miceous iron oxides, pure aluminum, coated aluminum, interference pigments (e.g., [P03] Interference Blue, [P04] Interference Gold, [P05] Interference Green, [P06] Interference Orange, [P07] Interference Red, [P08] Interference Violet), glass flakes, coated glass flakes, recycled cadmium pigments, crushed cadmium pigments, and/or ground cadmium pigments. See, for example, Dulux Protective Coatings, 2015, “MIO Coatings—What Are They?” Tech Note 5.2.1, available on the Internet at duluxprotectivecoatings.com.au/media/1464/521_mio_coatings-what_are_they.pdf.

In some implementations, the pigment includes any one or more colors selected from the Lawrence Berkeley National Laboratory Pigment Database (see, for instance, Levinson et al., Heat Island Group, Lawrence Berkeley National Laboratory, available on the Internet at CoolColors.LBL.gov). In some implementations, the pigment is black and/or brown. In some such implementations, the pigment is selected from the group consisting of [B01] Carbon Black, [B02] Ivory Black, [B03] Copper Chromite Black, [B04] Mars Black, [B05] Chrome Iron Nickel Black Spinel, [B06] Chromium Green-Black Hematite, [B07] Chromium Green-Black Hematite Modified (i), [B08] Chromium Green-Black Hematite Modified (ii), [B09] Chromium Green-Black Hematite Modified (iii), [B10] Chromium Iron Oxide (i), [B11] Chromium Iron Oxide (ii), [B12] Perylene Black, [B13] Burnt Sienna, [B14] Raw Sienna, [B15] Raw Umber, [B16] Iron Titanium Brown Spinel (i), [B17] Iron Titanium Brown Spinel (ii), [B18] Iron Titanium Brown Spinel (iii), [B19] Manganese Antimony Titanium Buff Rutile, [B20] Zinc Iron Chromite Brown Spinel (i), and [B21] Zinc Iron Chromite Brown Spinel (ii).

In some implementations, the pigment is blue and/or purple. In some such implementations, the pigment is selected from the group consisting of [U01] Cobalt Aluminate Blue Spinel (i), [U02] Cobalt Aluminate Blue Spinel (ii), [U03] Cobalt Aluminate Blue Spinel (iii), [U04] Cobalt Aluminum Blue, [U05] Cobalt Blue, [U06] Cerulean Blue, [U07] Cobalt Chromite Blue, [U08] Cobalt Chromite Blue-Green Spinel (i), [U09] Cobalt Chromite Blue-Green Spinel (ii), [10] Prussian Blue, [U11] French Ultramarine Blue, [U12] Phthalo Blue (i), [U13] Phthalo Blue (ii), and [U14] Dioxazine Purple.

In some implementations, the pigment is green. In some such implementations, the pigment is selected from the group consisting of [G01] Chrome Green, [G02] Chromium Oxide Green, [G03] Chromium Green-Black Modified, [G04] Cobalt Chromite Blue-Green Spinel (iii), [G05] Cobalt Chromite Green Spinel (i), [G06] Cobalt Chromite Green Spinel (ii), [G07] Cobalt Teal, [G08] Cobalt Titanate Green Spinel (i), [G09] Cobalt Titanate Green Spinel (ii), [G10] Phthalo Green (i), and [G11] Phthalo Green (ii).

In some implementations, the pigment is red and/or orange. In some such implementations, the pigment is selected from the group consisting of [R01] Red Iron Oxide (i), [R02] Red Iron Oxide (ii), [R03] Red Iron Oxide (iii), [R04] Red Oxide, [R05] Cadmium Orange, [R06] Acra Burnt Orange, [R07] Acra Red, [R08] Monastral Red, and [R09] Naphthol Red Light.

In some implementations, the pigment is yellow. In some such implementations, the pigment is selected from the group consisting of [Y01] Yellow Oxide, [Y02] Cadmium Yellow Light, [Y03] Chrome Yellow, [Y04] Chrome Antimony Titanium Buff Rutile (i), [Y05] Chrome Antimony Titanium Buff Rutile (ii), [Y06] Chrome Antimony Titanium Buff Rutile (iii), [Y07] Chrome Titanate Yellow, [Y08] Nickel Antimony Titanium Yellow Rutile (i), [Y09] Nickel Antimony Titanium Yellow Rutile (ii), [Y10] Nickel Antimony Titanium Yellow Rutile (iii), [Y11] Nickel Titanate Yellow, [Y12] Primer, [Y13] Yellow Medium Azo, [Y14] Yellow Orange Azo, and Bismuth Vanadate [PY184].

In some implementations, the pigment is pearlescent. In some such implementations, the pigment is selected from the group consisting of [P01] Bright Gold (Pearlescent), [PO2] Bright White (Pearlescent), [PO3] Interference Blue, [P04] Interference Gold, [P05] Interference Green, [P06] Interference Orange, [P07] Interference Red, [P08] Interference Violet, [P09] Iridescent White, [P10] Brass (Pearlescent), [P11] Bright Bronze (Pearlescent), [P12] Bright Copper (Pearlescent), [P13] Rich Bronze, and [P14] Russet (Pearlescent).

Pigments suitable for use in the present disclosure are further described in, e.g., Levinson et al., 2005, “Solar spectral properties of pigments, or how to design a cool nonwhite coating,” presented at Cool Roofing-Cutting Through the Glare, available on the Internet at coolcolors.lbl.gov/assets/docs/OtherTalks/HowToDesignACoolNonwhiteCoating.pdf

### V. Reducing Atmospheric Pollutants with an Asphalt-Based Sealcoat Composition

It has been found that titanium dioxide (TiO₂) nanoparticles can absorb the ultraviolet component of sunlight, acting as a catalyst to form reactive hydroxyl (OH) radicals in the presence of atmospheric moisture. These radicals have been found to oxidize and destroy most pollutant molecules.

The present technology, in some embodiments, is a method of reducing nitrogen oxides (NOx), volatile organic compounds (VOC), and other pollutants by an asphalt-based sealcoat composition comprising high levels of titanium oxide particles. The titanium oxide particles form a photocatalytic layer within the asphalt surface that oxidizes NOx and other pollutants when the treated asphalt surface is exposed to ultraviolet sunlight and airborne H₂O molecules. This process chemically alters the aforementioned pollutants, rendering them non-hazardous to the environment.

TiO₂ is a semiconductor material that, when exposed to ultraviolet (UV) radiation, as from sunlight, expels an electron from the valence band to the conduction band, leaving behind a positively charged hole. In the presence of water, as in atmospheric humidity, these positively charged holes create hydroxyl radicals as shown:

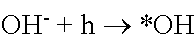

The hydroxyl radicals in turn oxidize nitrogen oxides as follows:

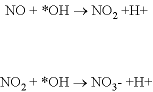

Other reactive effects occur with volatile organic compounds (VOC) and some other pollutants. Since TiO₂ functions as a catalyst and is not consumed in the reaction, the photocatalytic effect continues. If the TiO₂ is in place at the surface of an asphalt roadway, it removes a significant quantity of NOx and VOCs from the environment nearest their source.

In one aspect, the present disclosure relates to an asphalt-based sealcoat composition that reduces pollutants. In some embodiments, the asphalt-based sealcoat composition reduces atmospheric pollutants including an amount of nitrogen oxides (NOx) and volatile organic compounds (VOC) via photocatalytic reactions. In some embodiments, the asphalt-based sealcoat composition is highly solar reflective and reduces asphalt surface temperatures and pollutants. In some embodiments, the asphalt-based sealcoat composition has a SR (Solar Reflectivity) # of at least about 0.33 and reduces asphalt surface temperatures and pollutants.

In some embodiments, the titanium dioxide can act as a catalyst, which reacts with nitrogen oxides and other pollutants to chemically alter them into non-hazardous or less hazardous materials through photocatalytic oxidation (PCO) and/or reduction reaction.

In some embodiments, the techniques disclosed in Berdahl and Akbari, 2008, “Evaluation of Titanium Dioxide as a Photocatalyst for Removing Air Pollutants,” California Energy Commission, PIER Energy-Related Environmental Research Program, CEC-500-2007-112, the references cited therein, and the appendices thereof, can be used to determine the amount by which the compositions of the present disclosure can reduce air pollutants such as nitrogen oxide.

In some embodiments, the TiO₂ particles are doped with one or more modifiers selected from the group consisting of sulfur, vanadium, zinc, silver, aluminum, copper, iron, manganese, nickel, chromium, tin, barium, strontium, magnesium, cobalt, boron, molybdenum, tungsten, carbon, phosphorus, platinum, gold, and nitrogen.

Generally, the crystal structure of a titanium dioxide particle can influence its reflective and photocatalytic effects. In some embodiments, anatase is a more effective photocatalyst than rutile TiO₂ with the disadvantage of decreased reflectivity and fluorescence. One way to balance these effects is by blending grades and sources of titanium to achieve the desired effects. An alternative way is by “doping” or introducing alternative materials to the titanium dioxide matrix to tune the electron band gap of the crystal. This has the effect of altering the electron and electron hole densities across the titanium crystal lattice to balance reflectivity and photocatalytic effect (among others) in a single particle without the need for blending or other optimizations. See, for example, Thurston, “Band Gap Engineering Of Titania Systems Purposed For Photocatalytic Activity,” (2017), Electronic Theses and Dissertations, 1071; egrove.olemiss.edu/etd/1071; available on the Internet at egrove.olemiss.edu/cgi/viewcontent.cgi?article=2070&context=etd #:˜:text=In %20its%20ana tase%20form%2C%20titania,band%20gap%20nearing%203.2%20eV.

### VI. Preparation of Asphalt-Based Sealcoat Composition

In some embodiments, the asphalt-based sealcoat composition is prepared by mixing together a plurality of the components disclosed herein (e.g., selected from the group consisting of TiO₂ particles, an asphalt emulsion, water, polymer emulsion, clay, sand, extender, fiber, aggregate, biocide, dispersant, plasticizer, and/or dirt-resistance additive). In some embodiments, the asphalt-based sealcoat composition is prepared by mixing together at least an asphalt emulsion, water, an extender, sand, a polymer emulsion, clay, fiber, and a plurality of titanium oxide (TiO₂) particles present in an amount of about 10% to about 60% by weight.

In some embodiments, the asphalt-based sealcoat composition is prepared by mixing together one or more of TiO₂ particles (including, e.g., any of the embodiments and/or amounts disclosed herein, as in the section entitled “Titanium oxide,” above), asphalt emulsion (including, e.g., any of the embodiments and/or amounts disclosed herein, as in the section entitled “Asphalt,” above), water (including, e.g., any of the embodiments and/or amounts disclosed herein, as in the section entitled “Water,” above), polymer emulsion (including, e.g., any of the embodiments and/or amounts disclosed herein, as in the section entitled “Polymer Emulsion,” above), clay (including, e.g., any of the embodiments and/or amounts disclosed herein, as in the section entitled “Clay,” above), sand (including, e.g., any of the embodiments and/or amounts disclosed herein, as in the section entitled “Sand,” above), extender (including, e.g., any of the embodiments and/or amounts disclosed herein, as in the section entitled “Extenders,” above), fiber (including, e.g., any of the embodiments and/or amounts disclosed herein, as in the section entitled “Fiber,” above), aggregate (including, e.g., any of the embodiments and/or amounts disclosed herein, as in the section entitled “Aggregates,” above), biocide (including, e.g., any of the embodiments and/or amounts disclosed herein, as in the section entitled “Biocide,” above), dispersant (including, e.g., any of the embodiments and/or amounts disclosed herein, as in the section entitled “Dispersants,” above), plasticizer (including, e.g., any of the embodiments and/or amounts disclosed herein, as in the section entitled “Plasticizer,” above), and/or dirt-resistance additive (including, e.g., any of the embodiments and/or amounts disclosed herein, as in the section entitled “Dirt-Resistance Additives,” above). In some embodiments, the asphalt-based sealcoat composition is prepared by further adding a pigment (including, e.g., any of the embodiments and/or amounts disclosed herein, as in the section entitled “Reflectance of asphalt-based sealcoat composition,” above).

In some embodiments, the composition is prepared in a single mixing step.

In some embodiments, the composition is prepared in a plurality of mixing steps (e.g., phases).

In some embodiments, the composition is prepared by obtaining one or more intermediate mixtures. For example, intermediate mixtures can be obtained by mixing together two or more components of the composition in a separate step, prior to combining the intermediate mixture with the remaining components of the composition. In some embodiments, intermediate mixtures comprise any two or more components of the composition disclosed herein (e.g., TiO₂ particles, an asphalt emulsion, water, polymer emulsion, clay, sand, extender, fiber, aggregate, biocide, dispersant, plasticizer, and/or dirt-resistance additive). For example, an intermediate mixture can be an asphalt binder mixture comprising asphalt emulsion and polymer emulsion. In some embodiments, an intermediate mixture is a slurry comprising fiber, clay, water, and, optionally, sand. In some embodiments, an intermediate mixture comprises TiO₂ particles and dispersant (e.g., to homogenize the TiO₂ particles for dispersal throughout the asphalt-based sealcoat composition), and, optionally, extender and/or pigment. For instance, in some implementations, the preparation comprises mixing TiO₂ particles with water and/or a dispersant, emulsifying the TiO₂ particles to homogenize the TiO₂ particles, and adding the intermediate mixture to a final batch composition.

In some embodiments, a plurality of intermediate mixtures is obtained, and the plurality of intermediate mixtures are combined, together with any remaining components of the composition, to form the asphalt-based sealcoat composition. For instance, in some implementations, the preparation comprises (i) obtaining a first intermediate mixture comprising asphalt emulsion and polymer emulsion, a second intermediate mixture comprising fiber, clay, and water, and a third intermediate mixture comprising TiO₂ particles, dispersant, extender, and pigment, and (ii) combining the plurality of intermediate mixtures with the remaining components of the composition (e.g., sand, plasticizer, and/or biocide).

An example asphalt-based sealcoat composition preparation is described below with reference to Example 3. Briefly, a titanium dioxide asphalt-based sealcoat composition is prepared in a plurality of stages. In a first stage, a TiO₂ slurry is prepared using water, dispersant, TiO₂ particles, extender, and an infrared reflective, dark pigment. In a second stage, a clay slurry is prepared using water, fiber, clay, and biocide. In a third stage, the TiO₂ slurry and the clay slurry are combined with additional plasticizer, sand, polymer emulsion, asphalt emulsion, and biocide.

In some embodiments, the components of the asphalt-based sealcoat composition are added to the product as desired using any of the embodiments, amounts, and/or ranges disclosed herein. The disclosed compositions can be made using any suitable methods or in any order as will be apparent to one skilled in the art. For instance, the order of addition can be modified to any other order logically possible.

In some embodiments, the asphalt-based sealcoat composition has a pH of at least 8, at least 9, at least 10, at least 11, at least 12, or at least 13. In some embodiments, the asphalt-based sealcoat composition has a pH of from about 8 to about 14. In some embodiments, the asphalt-based sealcoat composition has a pH of about 10.

In some embodiments, prior to adding the asphalt emulsion, a mixture containing all other components of the asphalt-based sealcoat composition has a pH of at least 5, at least 6, at least 7, at least 8, at least 9, at least 10, at least 11, or at least 12. In some embodiments, a mixture containing all other components of the asphalt-based sealcoat composition except the asphalt emulsion has a pH of from about 5 to about 12. In some embodiments, a mixture containing all other components of the asphalt-based sealcoat composition except the asphalt emulsion has a pH of about 8.

Accordingly, in some embodiments, the asphalt-based sealcoat composition comprises an anionic emulsion. Advantageously, anionic emulsions can provide longer term stability for storage and transportation but may impact the drying time of the applied sealcoat composition. As described above, the addition of materials that impart enhanced stability allows for a wider variety of asphalt sources that can be used in the composition, resulting in improved product stability for storage and transportation and better control of drying and reactivity.

In some embodiments, the asphalt-based sealcoat composition is stable (e.g., can be stored) for at least 90 days. In some embodiments, the asphalt-based sealcoat composition is stable for at least 2 years. In some embodiments, the asphalt-based sealcoat composition is stable for at least 1 day, at least 2, days, at least 3 days, at least 4 days, at least 5 days, at least 6 days, or at least 1 week. In some embodiments, the asphalt-based sealcoat composition is stable for at least 2 weeks, at least 3 weeks, at least 1 month, at least 2 months, at least 3 months, at least 6 months, at least 1 year, at least 2 years, at least 3 years, at least 4 years, or at least 5 years. In some embodiments, the asphalt-based sealcoat composition is stable for no more than 10 years, no more than 5 years, no more than 2 years, no more than 1 year, no more than 6 months, or no more than 3 months. In some embodiments, the asphalt-based sealcoat composition is stable for between 1 day and 1 month, between 1 month and 6 months, between 2 months and 2 years, or between 6 months and 5 years. In some embodiments, the asphalt-based sealcoat composition is stable for another period of time starting no lower than 1 day and ending no higher than 10 years.

In some embodiments, the composition is prepared using a vertical high sheer mixer and/or a colloid mill. In some embodiments, the composition is prepared mechanically and/or manually. In some embodiments, one or more mixing steps (e.g., phases) are prepared using a vertical high sheer mixer. For instance, in some embodiments, the preparation of the asphalt-based sealcoat composition includes performing an asphalt emulsion using a vertical high sheer mixer. In some embodiments, one or more mixing steps (e.g., phases) are prepared using a colloid mill. For instance, in some embodiments, the preparation of the asphalt-based sealcoat composition includes performing an asphalt emulsion using a colloid mill.

In some embodiments, the composition is prepared (e.g., mixed) prior to transport to the point of application (e.g., in a factory). In some embodiments, the composition is stored for a period of time before being transported to the point of application (e.g., for a period of time starting no lower than 1 day and ending no higher than 10 years, as described above).

In some implementations, one or more components are added at a point of application. For example, in some implementations, one or more components of the asphalt-based sealcoat composition are added to the mixture no more than a predetermined period of time prior to application. In some embodiments, the predetermined period of time is no more than 1 day, no more than 12 hours, no more than 6 hours, no more than 3 hours, no more than 1 hours, or no more than 30 minutes. In some embodiments, the predetermined period of time is at least 5 minutes, at least 10 minutes, at least 20 minutes, at least 30 minutes, at least 1 hour, or at least 6 hours. In some embodiments, the predetermined period of time is from 10 minutes to 30 minutes, from 10 minutes to 1 hour, from 30 minutes to 6 hours, from 30 minutes to 12 hours, or from 6 hours to 1 day. In some embodiments, the predetermined period of time falls within another range starting no lower than 5 minutes and ending no higher than 1 day.

Any suitable means for mixing and/or adding components of the asphalt-based sealcoat composition are contemplated, as will be apparent to one skilled in the art. In some embodiments, any suitable unit of measurement can be used for adding components to the composition (e.g., weight, volume). In some embodiments, the composition is scaled to any desired batch size.

In some embodiments, the asphalt-based sealcoat composition has a weight (e.g., density) of at least 8.0, at least 8.5, at least 9.0, at least 9.5, at least 10.0, at least 10.5, at least 11.0, at least 11.2, at least 11.4, at least 11.5, at least 12.0, at least 12.5, at least 13.5, at least 14.0, at least 14.5, at least 15.0, at least 16.0, or at least 17.0 pounds per gallon. In some embodiments, the asphalt-based sealcoat composition has a weight of no more than 20.0, no more than 18.0, no more than 15.0, no more than 14.0, no more than 13.0, no more than 12.0, or no more than 11.0 pounds per gallon. In some embodiments, the asphalt-based sealcoat composition has a weight of from about 9.0 to about 12.0, from about 10.0 to about 14.0, from about 11.1 to about 11.8, from about 10.5 to about 13.5, or from about 8.0 to about 15.0 pounds per gallon. In some embodiments, the asphalt-based sealcoat composition has a weight falling within another range starting no lower than 8.0 pounds per gallon and ending no higher than 20.0 pounds per gallon. In some embodiments, the disclosed weights and/or weight ranges of the asphalt-based sealcoat composition reflect the weight of the composition just prior to application (e.g., ready-to-use). In some embodiments, the disclosed weights and/or weight ranges of the asphalt-based sealcoat composition reflect the weight of the composition prior to dilution (e.g., during manufacturing). In some embodiments, the weight is determined by the components included in the asphalt-based sealcoat composition (e.g., higher TiO₂ loadings result in proportionally higher densities). Advantageously, asphalt-based sealcoat compositions having higher weights can exhibit enhanced characteristics, including improved quality of application and sealcoat performance.

In some embodiments, as described below, the preparation comprises diluting the asphalt-based sealcoat composition after mixing the components together. In some embodiments, the preparation comprises diluting the asphalt-based sealcoat composition prior to application (e.g., to treat an asphalt surface).

### VII. Method of Treating Asphalt Surface with an Asphalt-Based Sealcoat Composition

In yet another aspect, the present disclosure relates to a method for treating an asphalt surface, the method comprising applying an amount of an asphalt-based sealcoat composition (e.g., any of the asphalt-based sealcoat compositions disclosed herein) to an upper surface of the asphalt surface. In some embodiments, the asphalt-based sealcoat composition is diluted with 1% to 50% additional water at the time of application. In some embodiments, the asphalt-based sealcoat composition is diluted with 10% to 30% additional water at the time of application. In some embodiments, the asphalt-based sealcoat composition is diluted with 15% to 25% additional water at the time of application. In some embodiments, the asphalt-based sealcoat composition is diluted with 20% additional water at the time of application.

In some embodiments, the method comprises treating any asphalt surface, including roads, sidewalks, playgrounds, parks, parking lots, driveways, recreational facilities, outdoor facilities, residential areas, schools, bike paths, shade structures, roofing, and LEED-certified building projects. In some embodiments, the method comprises treating an asphalt surface for any purpose, including recreational uses (e.g., tennis courts, basketball courts, running tracks, walking trails, biking paths, etc.), road markings (e.g., delineation of bike lanes, shoulders, lane lines, intersections, etc.), signage (e.g., handicapped parking, loading zones, pedestrian crossings, fire lanes, etc.), and/or aesthetic applications (e.g., driveways, courtyards, playgrounds, etc.). In some embodiments, the method comprises applying an amount of an asphalt-based sealcoat composition (e.g., any of the asphalt-based sealcoat compositions disclosed herein) to an asphalt surface that has undergone wear (e.g., cracking, discoloration, elongation, fracture, and/or general failure). The use of the asphalt-based sealcoat compositions disclosed herein is not limited to any specific purpose in any given context but can be used for any function in any context known in the art in which paving is used.

Additional embodiments for asphalt-based sealcoat compositions, methods of preparing and applying the same, and accompanying characteristics with respect to reflectivity values and reduction of pollutants are contemplated, as further described in International Application No. PCT/US2018/066431, filed 19 Dec. 2018, and U.S. Provisional Patent Application No. 62/608,881, filed 21 Dec. 2017, each of which is hereby incorporated herein by reference in its entirety.

### Further Embodiments

The following clauses describe specific embodiments of the disclosure.

Clause 1. An asphalt-based sealcoat composition comprising an asphalt emulsion, water, an extender, sand, a polymer emulsion, clay, fiber, and a plurality of titanium oxide (TiO₂) particles present in an amount of about 10% to about 60% by weight.

Clause 2. The composition of clause 1, wherein the TiO₂ particles are present in an amount of from about 18% to about 60% by weight.

Clause 3. The composition of clause 1 or clause 2, wherein the TiO₂ particles are present in an amount of from about 18% to about 50% by weight.

Clause 4. The composition of any one of clauses 1-3, wherein the TiO₂ particles are present in an amount of from about 18% to about 40% by weight.

Clause 5. The composition of any one of clauses 1-4, wherein the TiO₂ particles are present in an amount of from about 21% to about 30% by weight.

Clause 6. The composition of any one of clauses 1-5, wherein the TiO₂ particles are present in an amount of about 26% by weight to about 29% by weight.

Clause 7. The composition of any one of clauses 1-5, wherein the TiO₂ particles are present in an amount of about 23% by weight to about 26% by weight.

Clause 8. The composition of any one of clauses 1-5, wherein the TiO₂ particles are present in an amount of about 21% by weight to about 23% by weight.

Clause 9. The composition of clause 1, wherein the TiO₂ particles are present in an amount of about 8% by weight to about 12% by weight.

Clause 10. The composition of any one of clauses 1-9, wherein the asphalt emulsion is present in an amount of from about 5% to about 40% by weight.

Clause 11. The composition of any one of clauses 1-10, wherein the asphalt emulsion is present in an amount of from about 10% to about 35% by weight.

Clause 12. The composition of any one of clauses 1-11, wherein the asphalt emulsion present in an amount of from about 15% to about 30% by weight.

Clause 13. The composition of any one of clauses 1-12, wherein the asphalt emulsion is present in an amount of from about 15% to about 25% by weight.

Clause 14. The composition of any one of clauses 1-13, wherein the asphalt emulsion is present in an amount of from about 18% to about 23% by weight.

Clause 15. The composition of any one of clauses 1-14, wherein the asphalt emulsion is present in an amount of about 20% by weight.

Clause 16. The composition of any one of clauses 1-15, wherein the asphalt emulsion is selected from the group consisting of CSS-1h, CSS-1, SS-1h, SS-1, clay-based emulsions, and a mixture thereof.

Clause 17. The composition of any one of clauses 1-16, wherein the water is present in an amount of from about 15% to about 45% by weight.

Clause 18. The composition of any one of clauses 1-17, wherein the water is present in an amount of from about 18% to about 35% by weight.

Clause 19. The composition of any one of clauses 1-18, wherein the water is present in an amount of from about 20% to about 30% by weight.

Clause 20. The composition of any one of clauses 1-19, wherein the water is present in an amount of from about 22% to about 28% by weight.

Clause 21. The composition of any one of clauses 1-20, wherein the water is present in an amount of about 25% by weight.

Clause 22. The composition of any one of clauses 1-21, wherein the polymer emulsion is present in an amount of from about 1% to about 35% by weight.

Clause 23. The composition of any one of clauses 1-22, wherein the polymer emulsion is present in an amount of from about 3% to about 25% by weight.

Clause 24. The composition of any one of clauses 1-23, wherein the polymer emulsion is present in an amount of from about 4% to about 20% by weight.

Clause 25. The composition of any one of clauses 1-24, wherein the polymer emulsion is present in an amount of from about 6% to about 17% by weight.

Clause 26. The composition of any one of clauses 1-25, wherein the polymer emulsion is present in an amount of about 12% by weight to about 14% by weight.

Clause 27. The composition of any one of clauses 1-26, wherein the polymer emulsion is selected from the group consisting of acrylic copolymer, vinyl acrylic, acrylic latex, polyurethane, SBR (styrene-buladiene rubber), SBS (styrene-butadiene-styrene), polychloroprene, polyvinyl acetate, polyvinyl acetate ether, polyvinyl alcohols, parboxylic acid, synthetic Rubber, natural rubber, recycled tire rubber, LDP (low density polyethylene), EVA (ethaline vinyl acetate), nitrile latex, DuPont Elvaloy Polymer Modifier, and a mixture thereof.

Clause 28. The composition of any one of clauses 1-27, wherein the polymer emulsion comprises acrylic latex.

Clause 29. The composition of any one of clauses 1-28, wherein the clay is present in an amount of from about 1% to about 10% by weight.

Clause 30. The composition of any one of clauses 1-29, wherein the clay is present in an amount of from about 2% to about 8% by weight.

Clause 31. The composition of any one of clauses 1-30, wherein the clay is present in an amount of from about 3% to about 6% by weight.

Clause 32. The composition of any one of clauses 1-31, wherein the clay is present in an amount of from about 3% to about 5% by weight.

Clause 33. The composition of any one of clauses 1-32, wherein the clay is present in an amount of about 3.4% by weight.

Clause 34. The composition of any one of clauses 1-33, wherein the clay is selected from the group consisting of bentonite clay, ball clay, fire clay, sepiolite clay, illite, montmorillonite, hawthorn clay, American colloid clay, hickory clay, Lincoln clay, and a mixture thereof.

Clause 35. The composition of any one of clauses 1-34, wherein the clay is Bentonite clay.

Clause 36. The composition of any one of clauses 1-34, wherein the clay is sepiolite clay.

Clause 37. The composition of any one of clauses 1-36, wherein the sand is present in an amount of about 3% to about 25% by weight.

Clause 38. The composition of any one of clauses 1-37, wherein the sand is present in an amount of from about 4% to about 20% by weight.

Clause 39. The composition of any one of clauses 1-38, wherein the sand is present in an amount of from about 6% to about 16% by weight.

Clause 40. The composition of any one of clauses 1-39, wherein the sand is present in an amount of about 6% by weight to about 8% by weight.

Clause 41. The composition of any one of clauses 1-39, wherein the sand is present in an amount of about 14% by weight to about 16% by weight.

Clause 42. The composition of any one of clauses 1-41, wherein the sand has a particle size mesh from about 16 to about 300.

Clause 43. The composition of any one of clauses 1-42, wherein the sand has a particle size mesh from about 20 to about 280.

Clause 44. The composition of any one of clauses 1-43, wherein the sand has a particle size mesh from about 80 to about 240.

Clause 45. The composition of any one of clauses 1-44, wherein the sand has a particle size mesh from about 100 to about 220.

Clause 46. The composition of any one of clauses 1-45, wherein the sand has a particle size mesh of about 200.

Clause 47. The composition of any one of clauses 1-42, wherein the sand has a particle size mesh from about 20 to about 80.

Clause 48. The composition of clause 47, wherein the sand has a particle size mesh of about 20/40.

Clause 49. The composition of any one of clauses 1-48, wherein the extender is present in an amount of from about 1% to about 30% by weight.

Clause 50. The composition of any one of clauses 1-49, wherein the extender is present in an amount of from about 2% to about 8% by weight.

Clause 51. The composition of any one of clauses 1-50, wherein the extender is present in an amount of from about 3% to about 5% by weight.

Clause 52. The composition of any one of clauses 1-51, wherein the extender is present in an amount of about 3.1% by weight.

Clause 53. The composition of any one of clauses 1-51, wherein the extender is present in an amount of about 4.1% by weight.

Clause 54. The composition of any one of clauses 1-49, wherein the extender is present in an amount of from about 15% to about 25% by weight.

Clause 55. The composition of clause 54, wherein the extender is present in an amount of about 17.2% by weight.

Clause 56. The composition of any one of clauses 1-55, wherein the extender is selected from the group consisting of marble white, granulated calcium carbonate, kaolin, kaolinite, imerys talcs, Grace SYLOWHITE™, Burgess Pigment Company kaolins, and any mixture thereof.

Clause 57. The composition of any one of clauses 1-56, wherein the extender is granulated calcium carbonate.

Clause 58. The composition of any one of clauses 1-57, wherein the fiber is present in an amount of from about 0.1% to about 5% by weight.

Clause 59. The composition of any one of clauses 1-58, wherein the fiber is present in an amount of from about 0.3% to about 3% by weight.

Clause 60. The composition of any one of clauses 1-59, wherein the fiber is present in an amount of from about 0.5% to about 2% by weight.

Clause 61. The composition of any one of clauses 1-60, wherein the fiber is present in an amount of about 0.6% by weight.

Clause 62. The composition of any one of clauses 1-61, wherein the fiber is recycled paper or fabric.

Clause 63. The composition of any one of clauses 1-62, further comprising an aggregate present in an amount of from about 0.1% to about 25% by weight.

Clause 64. The composition of clause 63, wherein the aggregate is present in an amount of from about 0.5% to about 20% by weight.

Clause 65. The composition of clause 63 or clause 64, wherein the aggregate is present in an amount of from about 0.9% to about 15% by weight.

Clause 66. The composition of any one of clauses 63-65, wherein the aggregate is present in an amount of about 7% by weight.

Clause 67. The composition of any one of clauses 63-66, wherein the aggregate is selected from the group consisting of slate, baghouse fines (rock dust), fly ash, quartz sand, silica sand, calcium carbonite, clay, paper fiber, fiberglass fiber, limestone aggregate, copper slag, iron slag, steel slag, aluminum oxide, recycled roofing shingles, ground leather, ground rubber, nylon flock, plastic flock, glass beads, granite aggregate, ground tire rubber, ground up tennis balls, recycled cardboard, recycled glass, wood chips, wood fiber, walnut shells, apricot shells, pecan shells, corn cobs, rice hulls, scrabbled stone, pumice, basaltic aggregate, perlite, vermiculite, marble white, melamine, urea, calcinated bauxite, and any combination thereof.

Clause 68. The composition of any one of clauses 63-67, wherein the aggregate is limestone aggregate.

Clause 69. The composition of any one of clauses 1-68, further comprising biocide present in an amount of from about 0.01% to about 5% by weight.

Clause 70. The composition of clause 69, wherein the biocide is present in an amount of from about 0.1% to about 2% by weight.

Clause 71. The composition of clause 69 or clause 70, wherein the biocide is present in an amount of about 0.2% by weight.

Clause 72. The composition of clause 1, wherein the asphalt emulsion is present in an amount of about 18% to 22% by weight, the water is present in the amount of about 23% to 27% by weight, the extender is present in an amount of about 3% by weight to about 6% by weight, the sand is present in an amount of about 5% to about 9% by weight, the polymer emulsion is present in an amount of about 12% to about 16% by weight, the clay is present in an amount of about 2% to about 5% by weight, the fiber is present in an amount of about 0.1% to about 1% by weight, and TiO₂ is present in an amount of from about 18% to about 35% by weight, the asphalt emulsion comprises SS-1h, the extender comprises granulated calcium carbonate, the sand has a particle size mesh of about 100 to about 300, the polymer emulsion comprises acrylic latex, and the clay comprises Bentonite clay, and the composition further comprises biocide present in an amount of about 0.1% to about 0.5% by weight.

Clause 73. The composition of clause 1, wherein the asphalt emulsion is present in an amount of about 18% to about 22% by weight, the water is present in the amount of about 23% to about 27% by weight, the extender is present in an amount of about 12% to about 19% by weight, the sand is present in an amount of about 5% to about 9% by weight, the polymer emulsion is present in an amount of about 12% to about 16% by weight, the clay is present in an amount of about 2% to about 5% by weight, the fiber is present in an amount of about 0.1% to about 1% by weight, and TiO₂ is present in an amount of about 5% about 20% by weight, the asphalt emulsion comprises SS-1h, the extender comprises granulated calcium carbonate, the sand has a particle size mesh of about 100 to about 300, the polymer emulsion comprises acrylic latex, and the clay comprises Bentonite clay, and the composition further comprises biocide present in an amount of about 0.1% to about 0.5% by weight.

Clause 74. The composition of any one of clauses 1-73, further comprising a dispersant present in an amount of about 0.01% to about 10% by weight.

Clause 75. The composition of clause 74, wherein the dispersant is present in an amount of from about 0.03% to about 3% by weight.

Clause 76. The composition of clause 74 or clause 75, wherein the dispersant is present in an amount of from about 0.05% to about 1% by weight.

Clause 77. The composition of any one of clauses 74-76, wherein the dispersant is selected from the group consisting of polyacrylic acid, copolymers, polyurethanes, polyacrylates, star-shaped dispersing polymers, block copolymers, controlled free radical polymerization (CFRP), and amines.

Clause 78. The composition of any one of clauses 74-77, wherein the dispersant is 2-amino-2-methyl-1-propanol.

Clause 79. The composition of any one of clauses 1-78, further comprising a plasticizer present in an amount of about 0.1% to about 20% by weight.

Clause 80. The composition of clause 79, wherein the plasticizer is present in an amount of from about 0.5% to about 10% by weight.

Clause 81. The composition of clause 7979 or clause 80, wherein the plasticizer is present in an amount of from about 1% to about 5% by weight.

Clause 82. The composition of any one of clauses 79-81, wherein the plasticizer is selected from the group consisting of low molecular weight ortho phthalates, high molecular weight ortho phthalates, trimellitates, adipates, sebacates, glycerol triacetate, alkyl citrates, azelates, dibenzoates, terephthalates, gluterates, organophosphates, polycarboxylate ether, polycarboxylate, sulfonated naphthalene condensate, and sulfonated melamine formaldehyde.

Clause 83. The composition of any one of clauses 79-82, wherein the plasticizer is a low volatile organic compound (VOC) plasticizer.

Clause 84. The composition of any one of clauses 1-83, wherein the asphalt-based sealcoat composition is highly solar reflective.

Clause 85. The composition of any one of clauses 1-84, wherein the asphalt-based sealcoat has a SR (Solar Reflectivity) # of at least about 0.10.

Clause 86. The composition of any one of clauses 1-85, wherein the asphalt-based sealcoat has a SR # of at least about 0.20.

Clause 87. The composition of any one of clauses 1-86, wherein the asphalt-based sealcoat has a SR # of at least about 0.30.

Clause 88. The composition of any one of clauses 1-87, wherein the asphalt-based sealcoat has a SR # of at least about 0.33.

Clause 89. The composition of any one of clauses 1-88, wherein the asphalt-based sealcoat has a SR # of at least about 0.35.

Clause 90. The composition of any one of clauses 1-86, wherein the asphalt-based sealcoat has a SR # of from about 0.20 to about 0.60.

Clause 91. The composition of any one of clauses 1-90, wherein the asphalt-based sealcoat has an SRI (Solar Reflective Index) # of at least about 10.

Clause 92. The composition of any one of clauses 1-91, wherein the asphalt-based sealcoat has an SRI # of at least about 20.

Clause 93. The composition of any one of clauses 1-92, wherein the asphalt-based sealcoat has an SRI # of at least about 30.

Clause 94. The composition of any one of clauses 1-93, wherein the asphalt-based sealcoat has an SRI # of at least about 35.

Clause 95. The composition of any one of clauses 1-92, wherein the asphalt-based sealcoat has an SRI # of from about 20 to about 60.

Clause 96. The composition of any one of clauses 1-95, wherein the asphalt-based sealcoat composition reduces surface temperatures of asphalt treated with the asphalt-based sealcoat composition compared to asphalt not treated with asphalt-based sealcoat composition.

Clause 97. The composition of any one of clauses 1-96, further comprising a pigment present in an amount of about 0.01% to about 5% by weight.

Clause 98. The composition of clause 97, wherein the pigment is present in an amount of from about 0.05% to about 1% by weight.

Clause 99. The composition of clause 97 or clause 98, wherein the pigment is present in an amount of from about 0.1% to about 0.5% by weight.

Clause 100. The composition of any one of clauses 97-99, wherein the pigment is an infrared reflective, dark pigment.

Clause 101. The composition of any one of clauses 97-100, wherein the pigment is selected from the group consisting of red iron oxides, yellow iron oxides, phthalocyanine blue, perelyene black, chromic oxides (Cr₂O₃), ferric oxides (Fe₂O₃), white titanates, yellow titanates, green titanates, brown titanates, brown iron oxides, black iron oxides, miceous iron oxides, cadmium orange, cadmium yellow, and chromium iron oxides.

Clause 102. The composition of any one of clauses 97-101, wherein the pigment is chromium green-black hematite.

Clause 103. The composition of any one of clauses 1-102, wherein the TiO₂ particles comprise an anatase powder form of TiO₂.

Clause 104. The composition of any one of clauses 1-102, wherein the TiO₂ particles comprise a brookite powder form of TiO₂.

Clause 105. The composition of any one of clauses 1-102, wherein the TiO₂ particles comprise a rutile powder form of TiO₂.

Clause 106. The composition of any one of clauses 1-105, wherein each respective TiO₂ particle in the plurality of TiO₂ particles comprises a modifier.

Clause 107. The composition of clause 106, wherein the modifier is an aluminum hydroxide coating.

Clause 108. The composition of any one of clauses 1-107, wherein each respective TiO₂ particle in the plurality of TiO₂ particles has a size of no more than 20 microns.

Clause 109. The composition of any one of clauses 1-108, wherein each respective TiO₂ particle in the plurality of TiO₂ particles has a size of no more than 10 microns.

Clause 110. The composition of any one of clauses 1-109, wherein each respective TiO₂ particle in the plurality of TiO₂ particles has a size of no more than 5 microns.

Clause 111. The composition of any one of clauses 1-110, further comprising an asphalt reinforcement component.

Clause 112. The composition of clause 111, wherein the asphalt reinforcement component is selected from the group consisting of mineral asphaltenes, clarified asphalt, and bio-based asphalt-like binders.

Clause 113. The composition of any one of clauses 1-112, wherein the asphalt-based sealcoat composition reduces pollutants.

Clause 114. The composition of clause 113, wherein the asphalt-based sealcoat composition reduces atmospheric pollutants including an amount of nitrogen oxides (NOx) and volatile organic compounds (VOC) via photocatalytic reactions.

Clause 115. The composition of clause 113 or clause 114, wherein the asphalt-based sealcoat composition is highly solar reflective and reduces asphalt surface temperatures and pollutants.

Clause 116. The composition of any one of clauses 113-115, wherein the asphalt-based sealcoat composition has a SR (Solar Reflectivity) # of at least about 0.33 and reduces asphalt surface temperatures and pollutants.

Clause 117. The composition of any one of clauses 1-116, wherein the asphalt-based sealcoat has a skid number (SN40R) of at least about 25.

Clause 118. The composition of any one of clauses 1-117, wherein the asphalt-based sealcoat has an SN40R of at least about 30.

Clause 119. The composition of any one of clauses 1-118, wherein the asphalt-based sealcoat has an SN40R of at least about 35.

Clause 120. The composition of any one of clauses 1-119, wherein the asphalt-based sealcoat has a dynamic friction test (DFT) value of at least about 0.35.

Clause 121. The composition of any one of clauses 1-120, wherein the asphalt-based sealcoat has a DFT value of at least about 0.4.

Clause 122. The composition of any one of clauses 1-121, wherein the asphalt-based sealcoat has a DFT value of at least about 0.45.

Clause 123. The composition of any one of clauses 1-122, further comprising a dirt-resistance additive.

Clause 124. The composition of clause 123, wherein the dirt-resistance additive is colloidal silica.

Clause 125. A method for treating an asphalt surface, the method comprising applying an amount of an asphalt-based sealcoat composition of any of clauses 1-124 to an upper surface of the asphalt surface.

Clause 126. The method of clause 125, wherein at the time of application the asphalt-based sealcoat composition is diluted with 1% to 50% additional water.

Clause 127. The method of clause 125 or clause 126, wherein at the time of application the asphalt-based sealcoat composition is diluted with 10% to 30% additional water.

Clause 128. The method of any one of clauses 125-127, wherein at the time of application the asphalt-based sealcoat composition is diluted with 15% to 25% additional water.

Clause 129. The method of any one of clauses 125-128, wherein at the time of application the asphalt-based sealcoat composition is diluted with 20% additional water.

Clause 130. The composition of any one of clauses 1-124, wherein the TiO₂ particles are doped with one or more modifiers selected from the group consisting of sulfur, vanadium, zinc, silver, aluminum, copper, iron, manganese, nickel, chromium, tin, barium, strontium, magnesium, cobalt, boron, molybdenum, tungsten, carbon, phosphorus, platinum, gold, and nitrogen.

### EXAMPLES

The following Examples illustrate the synthesis of representative compounds used in the invention and the following Reference Examples illustrate the synthesis of intermediates in their preparation. These examples are not intended, nor are they to be construed, as limiting the scope of the invention. It will be clear that the invention may be practiced otherwise than as particularly described herein. Numerous modifications and variations of the invention are possible in view of the teachings herein and, therefore, are within the scope of the invention.

In the examples below, unless otherwise indicated, all temperatures are set forth in degrees Celsius and all parts and percentages are by weight. Reagents may be purchased from commercial suppliers and may be used without further purification unless otherwise indicated. Reagents may also be prepared following standard literature procedures known to those skilled in the art. Solvents may be purchased from commercial suppliers and may be used as received unless otherwise indicated. All solvents may be purified using standard methods known to those skilled in the art, unless otherwise indicated.

Starting materials used were either available from commercial sources or prepared according to literature procedures and had experimental data in accordance with those reported.

### Example 1—Preparation of Asphalt Compositions in Accordance with the Present Disclosure

Coolseal-UP 7814. A batch of titanium dioxide pigmented asphalt emulsion entitled batch “Coolseal UP 7814” was prepared by forming 37,010 pounds of a slurry in a vertical high sheer mixer. The slurry consisted of 3,532 gallons of water, 1,588 pounds of fiber, and 6,004 pounds of clay. A total of 12,390 pounds (1,332 gallons) of this slurry was then used as a starting point to make the titanium dioxide pigmented asphalt emulsion. To the 12,390 pounds of slurry was added 17,139 pounds of TiO₂ and 3,545 pounds of sand. After thorough mixing, 11,568 pounds (1,389 gallons) of oil (CSS), 3,184 pounds (375 gallons) of latex, 943 pounds (118 gallons) of polymer emulsion (UP7814), and 1,479 pounds (178 gallons) of additional water were added, resulting in a batch of 50,248 pounds of titanium dioxide pigmented asphalt emulsion. The composition of the batch by weight was about 22.59 percent water, 1.06 percent fiber, 4.01 percent clay, 34.18 percent TiO₂, 7.07 percent sand, 23.07 percent oil (CSS), 6.35 percent latex, and 1.88 percent polymer emulsion (UP7814).

Rose Paving. A batch of titanium dioxide pigmented asphalt emulsion entitled batch “Rose Paving” was prepared by forming 37,008 pounds of a slurry in a vertical high sheer mixer. The slurry consisted of 3,531 gallons of water, 1,588 pounds of fiber, and 6,003 pounds of clay. A total of 12,638 pounds (1,359 gallons) of this slurry was then used as a starting point to make the titanium dioxide pigmented asphalt emulsion. To the 12,638 pounds of slurry was added 16,339 pounds of TiO₂ and 5,125 pounds of sand. After thorough mixing, 11,469 pounds (1,377 gallons) of oil (CSS), 3,576 pounds (421 gallons) of latex (Etonis 142), and 1,003 pounds (120 gallons) of additional water were added, resulting in a batch of 50,150 pounds of titanium dioxide pigmented asphalt emulsion. The composition of the batch by weight was 22.03 percent water, 1.08 percent fiber, 4.09 percent clay, 32.58 percent TiO₂, 10.22 percent sand, 22.87 percent oil (CSS), and 7.13 percent latex (Etonis 142).

Batch GT-102. A batch of titanium dioxide pigmented asphalt emulsion entitled batch “GT-102” was prepared by forming 37,008 pounds of a slurry in a vertical high sheer mixer. The slurry consisted of 3,531 gallons of water, 1,588 pounds of fiber, and 6,003 pounds of clay. A total of 1,890 pounds (203 gallons) of this slurry was then used as a starting point to make the titanium dioxide pigmented asphalt emulsion. To the 1,890 pounds of slurry was added 2,444 pounds of TiO₂ and 767 pounds of sand. After thorough mixing, 1,715 pounds (206 gallons) of oil (CSS), 535 pounds (63 gallons) of latex (Etonis 142), and 150 pounds (18 gallons) of additional water were added, resulting in a batch of 7,500 pounds of titanium dioxide pigmented asphalt emulsion. The composition of the batch by weight was 22.03 percent water, 1.08 percent fiber, 4.09 percent clay, 32.58 percent TiO₂, 10.22 percent sand, 22.87 percent oil (CSS), and 7.13 percent latex (Etonis 142).

Batch Coolseal 2. A batch of titanium dioxide pigmented asphalt emulsion entitled batch “Coolseal 2” was prepared by forming 37,014 pounds of a slurry in a vertical high sheer mixer. The slurry consisted of 3,765 gallons of water, 751 pounds of fiber, and 4,893 pounds of clay (sepiolite). A total of 12,081 pounds (1,299 gallons) of this slurry was then used as a starting point to make the titanium dioxide pigmented asphalt emulsion. To the 12,081 pounds of slurry was added 17,206 pounds of TiO₂ and 3546 pounds of sand. After thorough mixing, 11,775 pounds (1,414 gallons) of oil (CSS), 3,867 pounds of latex (Etonis 142), and 1,535 pounds (184 gallons) of additional water were added, resulting in a batch of 50,010 pounds of titanium dioxide pigmented asphalt emulsion. The composition of the batch by weight was about 23.47 percent water, 0.49 percent fiber, 3.18 percent clay, 34.31 percent TiO₂, 7.07 percent sand, 23.48 percent oil (CSS), and 7.71 percent latex (Etonis 142).

### Example 2—Example Asphalt Composition in Accordance with the Present Disclosure

A batch of asphalt-based sealcoat composition was prepared in a colloid mill. The asphalt-based sealcoat composition consisted of 1,000 gallons of water, 1,200 pounds of clay, 12,870 pounds of TiO₂, 1,430 pounds of extender, 3,400 pounds of sand, an asphalt emulsion comprising 1,205 gallons of asphalt and 150 gallons of water, 410 gallons of self-crosslinking acrylic polymer, 410 gallons of EVA latex polymer, 300 pounds of fiber, and 500 pounds of clay, resulting in a batch of 46,288 pounds of titanium dioxide pigmented asphalt-based sealcoat composition. The composition of the batch by weight was about 20.7% water, 2.59% clay, 27.80% TiO₂, 3.09% extender, 7.35% sand, 21.69% asphalt, 15.06% polymer, 0.65% fiber, and 1.08% clay.

### Example 3—Additional Example Asphalt Compositions in Accordance with the Present Disclosure

Example CoolSeal Batch. A batch of asphalt-based sealcoat composition was prepared in a plurality of phases. In a first phase, a TiO₂ slurry was obtained as a first intermediate mixture. The first intermediate mixture consisted of water in an amount of about 8.9% by weight, dispersant in an amount of about 0.07% by weight, TiO₂ in an amount of about 24.2% by weight, and extender in an amount of about 4.2% by weight. In a second phase, a clay slurry was obtained as a second intermediate mixture. The clay slurry consisted of water in an amount of about 16.5% by weight, fiber in an amount of about 0.6% by weight, clay in an amount of about 3.4% by weight, and biocide in an amount of about 0.1% by weight. In a third phase, the first intermediate mixture and the second intermediate mixture were combined with additional components including plasticizer in an amount of about 1.4% by weight, sand in an amount of about 6.8% by weight, acrylic polymer in an amount of about 6.9% by weight, EVA latex polymer in an amount of about 6.9% by weight, asphalt emulsion in an amount of about 20% by weight, and biocide in an amount of about 0.1% by weight.

Example CoolShield Batch. A batch of asphalt-based sealcoat composition using a larger particle mesh size sand (e.g., 20/40) was prepared in a plurality of phases. In a first phase, a TiO₂ slurry was obtained as a first intermediate mixture. The first intermediate mixture consisted of water in an amount of about 6.9% by weight, dispersant in an amount of about 0.07% by weight, and TiO₂ in an amount of about 24% by weight. In a second phase, a clay slurry was obtained as a second intermediate mixture. The clay slurry consisted of water in an amount of about 16.9% by weight, fiber in an amount of about 0.61% by weight, clay in an amount of about 3.4% by weight, and biocide in an amount of about 0.1% by weight. In a third phase, the first intermediate mixture and the second intermediate mixture were combined with additional components including the larger particle mesh size sand (e.g., 20/40) in an amount of about 15% by weight, acrylic polymer in an amount of about 6.5% by weight, EVA latex polymer in an amount of about 6.5% by weight, asphalt emulsion in an amount of about 20% by weight, and biocide in an amount of about 0.1% by weight. The resulting composition exhibited a light color (e.g., grey and/or salt-and-pepper) due to the addition of the larger particle mesh size sand. In addition, the resulting composition exhibited anti-skid properties and solar reflective properties with an SRI # of 42, and further passed all required physicals.

Example Low TiO₂ CoolSeal Batch. A batch of asphalt-based sealcoat composition using a low amount of TiO₂ particles (e.g., about 10%) was prepared in a plurality of phases. In a first phase, a TiO₂ slurry was obtained as a first intermediate mixture. The first intermediate mixture consisted of water in an amount of about 10.2% by weight, dispersant in an amount of about 0.07% by weight, TiO₂ in an amount of about 10.7% by weight, extender in an amount of about 17.2% by weight, and infrared-reflective, dark pigment in an amount of about 0.25% by weight. In a second phase, a clay slurry was obtained as a second intermediate mixture. The clay slurry consisted of water in an amount of about 16.2% by weight, fiber in an amount of about 0.59% by weight, clay in an amount of about 3.4% by weight, and biocide in an amount of about 0.1% by weight. In a third phase, the first intermediate mixture and the second intermediate mixture were combined with additional components including plasticizer in an amount of about 1.4% by weight, sand in an amount of about 6.7% by weight, acrylic polymer in an amount of about 6.8% by weight, EVA latex polymer in an amount of about 6.8% by weight, asphalt emulsion in an amount of about 20% by weight, and biocide in an amount of about 0.1% by weight. The resulting composition advantageously was lower in cost due to the reduced amount of TiO₂ supplemented with extender yet exhibited sufficiently high solar reflective properties to pass LEED requirements with an SRI # of 38, and further passed all required physicals. Moreover, the addition of the infrared-reflective, dark pigment beneficially allowed the asphalt-based sealcoat composition to exhibit a visually appealing color that can be applied to existing paved surfaces such as roads, parking lots, driveways, and/or roofing.

### Example 4—Anti-Skid Properties of Asphalt Compositions in Accordance with the Present Disclosure

An asphalt-based sealcoat composition was prepared in accordance with an embodiment of the present disclosure and applied to a residential paved surface. A Locked Wheel Skid Test (LWST) was performed in accordance with ASTM E27406, using modified testing speeds that were lower than those used for standard highway tests to account for the lower speeds used on residential pavements. Skid number (SN40R) outputs from the LWST exceeded 30 with a target above 35, which equated to a dynamic friction test (DFT) value of at least 0.45. Accordingly, the asphalt-based sealcoat composition was deemed to meet and surpass requirements for pavement maintenance applications within the testing region (Los Angeles).

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. An asphalt-based sealcoat composition comprising an asphalt emulsion, water, an extender, sand, a polymer emulsion, clay, fiber, and a plurality of titanium oxide (TiO₂) particles present in an amount of about 10% to about 60% by weight.

2. The composition of claim 1, wherein the TiO₂ particles are present in an amount of from about 18% to about 60% by weight.

3. The composition of claim 1 or claim 2, wherein the TiO₂ particles are present in an amount of from about 18% to about 50% by weight.

4. The composition of any one of claims 1-3, wherein the TiO₂ particles are present in an amount of from about 18% to about 40% by weight.

5. The composition of any one of claims 1-4, wherein the TiO₂ particles are present in an amount of from about 21% to about 30% by weight.

6. The composition of any one of claims 1-5, wherein the TiO₂ particles are present in an amount of about 26% by weight to about 29% by weight.

7. The composition of any one of claims 1-5, wherein the TiO₂ particles are present in an amount of about 23% by weight to about 26% by weight.

8. The composition of any one of claims 1-5, wherein the TiO₂ particles are present in an amount of about 21% by weight to about 23% by weight.

9. The composition of claim 1, wherein the TiO₂ particles are present in an amount of about 8% by weight to about 12% by weight.

10. The composition of any one of claims 1-9, wherein the asphalt emulsion is present in an amount of from about 5% to about 40% by weight.

11. The composition of any one of claims 1-10, wherein the asphalt emulsion is present in an amount of from about 10% to about 35% by weight.

12. The composition of any one of claims 1-11, wherein the asphalt emulsion present in an amount of from about 15% to about 30% by weight.

13. The composition of any one of claims 1-12, wherein the asphalt emulsion is present in an amount of from about 15% to about 25% by weight.

14. The composition of any one of claims 1-13, wherein the asphalt emulsion is present in an amount of from about 18% to about 23% by weight.

15. The composition of any one of claims 1-14, wherein the asphalt emulsion is present in an amount of about 20% by weight.

16. The composition of any one of claims 1-15, wherein the asphalt emulsion is selected from the group consisting of CSS-1h, CSS-1, SS-1h, SS-1, clay-based emulsions, and a mixture thereof.

17. The composition of any one of claims 1-16, wherein the water is present in an amount of from about 15% to about 45% by weight.

18. The composition of any one of claims 1-17, wherein the water is present in an amount of from about 18% to about 35% by weight.

19. The composition of any one of claims 1-18, wherein the water is present in an amount of from about 20% to about 30% by weight.

20. The composition of any one of claims 1-19, wherein the water is present in an amount of from about 22% to about 28% by weight.

21. The composition of any one of claims 1-20, wherein the water is present in an amount of about 25% by weight.

22. The composition of any one of claims 1-21, wherein the polymer emulsion is present in an amount of from about 1% to about 35% by weight.

23. The composition of any one of claims 1-22, wherein the polymer emulsion is present in an amount of from about 3% to about 25% by weight.

24. The composition of any one of claims 1-23, wherein the polymer emulsion is present in an amount of from about 4% to about 20% by weight.

25. The composition of any one of claims 1-24, wherein the polymer emulsion is present in an amount of from about 6% to about 17% by weight.

26. The composition of any one of claims 1-25, wherein the polymer emulsion is present in an amount of about 12% by weight to about 14% by weight.

27. The composition of any one of claims 1-26, wherein the polymer emulsion is selected from the group consisting of acrylic copolymer, vinyl acrylic, acrylic latex, polyurethane, SBR (styrene-buladiene rubber), SBS (styrene-butadiene-styrene), polychloroprene, polyvinyl acetate, polyvinyl acetate ether, polyvinyl alcohols, parboxylic acid, synthetic Rubber, natural rubber, recycled tire rubber, LDP (low density polyethylene), EVA (ethaline vinyl acetate), nitrile latex, DuPont Elvaloy Polymer Modifier, and a mixture thereof.

28. The composition of any one of claims 1-27, wherein the polymer emulsion comprises acrylic latex.

29. The composition of any one of claims 1-28, wherein the clay is present in an amount of from about 1% to about 10% by weight.

30. The composition of any one of claims 1-29, wherein the clay is present in an amount of from about 2% to about 8% by weight.

31. The composition of any one of claims 1-30, wherein the clay is present in an amount of from about 3% to about 6% by weight.

32. The composition of any one of claims 1-31, wherein the clay is present in an amount of from about 3% to about 5% by weight.

33. The composition of any one of claims 1-32, wherein the clay is present in an amount of about 3.4% by weight.

34. The composition of any one of claims 1-33, wherein the clay is selected from the group consisting of bentonite clay, ball clay, fire clay, sepiolite clay, illite, montmorillonite, hawthorn clay, American colloid clay, hickory clay, Lincoln clay, and a mixture thereof.

35. The composition of any one of claims 1-34, wherein the clay is Bentonite clay.

36. The composition of any one of claims 1-34, wherein the clay is sepiolite clay.

37. The composition of any one of claims 1-36, wherein the sand is present in an amount of about 3% to about 25% by weight.

38. The composition of any one of claims 1-37, wherein the sand is present in an amount of from about 4% to about 20% by weight.

39. The composition of any one of claims 1-38, wherein the sand is present in an amount of from about 6% to about 16% by weight.

40. The composition of any one of claims 1-39, wherein the sand is present in an amount of about 6% by weight to about 8% by weight.

41. The composition of any one of claims 1-39, wherein the sand is present in an amount of about 14% by weight to about 16% by weight.

42. The composition of any one of claims 1-41, wherein the sand has a particle size mesh from about 16 to about 300.

43. The composition of any one of claims 1-42, wherein the sand has a particle size mesh from about 20 to about 280.

44. The composition of any one of claims 1-43, wherein the sand has a particle size mesh from about 80 to about 240.

45. The composition of any one of claims 1-44, wherein the sand has a particle size mesh from about 100 to about 220.

46. The composition of any one of claims 1-45, wherein the sand has a particle size mesh of about 200.

47. The composition of any one of claims 1-42, wherein the sand has a particle size mesh from about 20 to about 80.

48. The composition of claim 47, wherein the sand has a particle size mesh of about 20/40.

49. The composition of any one of claims 1-48, wherein the extender is present in an amount of from about 1% to about 30% by weight.

50. The composition of any one of claims 1-49, wherein the extender is present in an amount of from about 2% to about 8% by weight.

51. The composition of any one of claims 1-50, wherein the extender is present in an amount of from about 3% to about 5% by weight.

52. The composition of any one of claims 1-51, wherein the extender is present in an amount of about 3.1% by weight.

53. The composition of any one of claims 1-51, wherein the extender is present in an amount of about 4.1% by weight.

54. The composition of any one of claims 1-49, wherein the extender is present in an amount of from about 15% to about 25% by weight.

55. The composition of claim 54, wherein the extender is present in an amount of about 17.2% by weight.

56. The composition of any one of claims 1-55, wherein the extender is selected from the group consisting of marble white, granulated calcium carbonate, kaolin, kaolinite, imerys talcs, Grace SYLOWHITE™, Burgess Pigment Company kaolins, and any mixture thereof.

57. The composition of any one of claims 1-56, wherein the extender is granulated calcium carbonate.

58. The composition of any one of claims 1-57, wherein the fiber is present in an amount of from about 0.1% to about 5% by weight.

59. The composition of any one of claims 1-58, wherein the fiber is present in an amount of from about 0.3% to about 3% by weight.

60. The composition of any one of claims 1-59, wherein the fiber is present in an amount of from about 0.5% to about 2% by weight.

61. The composition of any one of claims 1-60, wherein the fiber is present in an amount of about 0.6% by weight.

62. The composition of any one of claims 1-61, wherein the fiber is recycled paper or fabric.

63. The composition of any one of claims 1-62, further comprising an aggregate present in an amount of from about 0.1% to about 25% by weight.

64. The composition of claim 63, wherein the aggregate is present in an amount of from about 0.5% to about 20% by weight.

65. The composition of claim 63 or claim 64, wherein the aggregate is present in an amount of from about 0.9% to about 15% by weight.

66. The composition of any one of claims 63-65, wherein the aggregate is present in an amount of about 7% by weight.

67. The composition of any one of claims 63-66, wherein the aggregate is selected from the group consisting of slate, baghouse fines (rock dust), fly ash, quartz sand, silica sand, calcium carbonite, clay, paper fiber, fiberglass fiber, limestone aggregate, copper slag, iron slag, steel slag, aluminum oxide, recycled roofing shingles, ground leather, ground rubber, nylon flock, plastic flock, glass beads, granite aggregate, ground tire rubber, ground up tennis balls, recycled cardboard, recycled glass, wood chips, wood fiber, walnut shells, apricot shells, pecan shells, corn cobs, rice hulls, scrabbled stone, pumice, basaltic aggregate, perlite, vermiculite, marble white, melamine, urea, calcinated bauxite, and any combination thereof.

68. The composition of any one of claims 63-67, wherein the aggregate is limestone aggregate.

69. The composition of any one of claims 1-68, further comprising biocide present in an amount of from about 0.01% to about 5% by weight.

70. The composition of claim 69, wherein the biocide is present in an amount of from about 0.1% to about 2% by weight.

71. The composition of claim 69 or claim 70, wherein the biocide is present in an amount of about 0.2% by weight.

72. The composition of claim 1, wherein the asphalt emulsion is present in an amount of about 18% to 22% by weight, the water is present in the amount of about 23% to 27% by weight, the extender is present in an amount of about 3% by weight to about 6% by weight, the sand is present in an amount of about 5% to about 9% by weight, the polymer emulsion is present in an amount of about 12% to about 16% by weight, the clay is present in an amount of about 2% to about 5% by weight, the fiber is present in an amount of about 0.1% to about 1% by weight, and TiO₂ is present in an amount of from about 18% to about 35% by weight,
the asphalt emulsion comprises SS-1h, the extender comprises granulated calcium carbonate, the sand has a particle size mesh of about 100 to about 300, the polymer emulsion comprises acrylic latex, and the clay comprises Bentonite clay, and
the composition further comprises biocide present in an amount of about 0.1% to about 0.5% by weight.

73. The composition of claim 1, wherein the asphalt emulsion is present in an amount of about 18% to about 22% by weight, the water is present in the amount of about 23% to about 27% by weight, the extender is present in an amount of about 12% to about 19% by weight, the sand is present in an amount of about 5% to about 9% by weight, the polymer emulsion is present in an amount of about 12% to about 16% by weight, the clay is present in an amount of about 2% to about 5% by weight, the fiber is present in an amount of about 0.1% to about 1% by weight, and TiO₂ is present in an amount of about 5% about 20% by weight,
the asphalt emulsion comprises SS-1h, the extender comprises granulated calcium carbonate, the sand has a particle size mesh of about 100 to about 300, the polymer emulsion comprises acrylic latex, and the clay comprises Bentonite clay, and
the composition further comprises biocide present in an amount of about 0.1% to about 0.5% by weight.

74. The composition of any one of claims 1-73, further comprising a dispersant present in an amount of about 0.01% to about 10% by weight.

75. The composition of claim 74, wherein the dispersant is present in an amount of from about 0.03% to about 3% by weight.

76. The composition of claim 74 or claim 75, wherein the dispersant is present in an amount of from about 0.05% to about 1% by weight.

77. The composition of any one of claims 74-76, wherein the dispersant is selected from the group consisting of polyacrylic acid, copolymers, polyurethanes, polyacrylates, star-shaped dispersing polymers, block copolymers, controlled free radical polymerization (CFRP), and amines.

78. The composition of any one of claims 74-77, wherein the dispersant is 2-amino-2-methyl-1-propanol.

79. The composition of any one of claims 1-78, further comprising a plasticizer present in an amount of about 0.1% to about 20% by weight.

80. The composition of claim 79, wherein the plasticizer is present in an amount of from about 0.5% to about 10% by weight.

81. The composition of claim 7979 or claim 80, wherein the plasticizer is present in an amount of from about 1% to about 5% by weight.

82. The composition of any one of claims 79-81, wherein the plasticizer is selected from the group consisting of low molecular weight ortho phthalates, high molecular weight ortho phthalates, trimellitates, adipates, sebacates, glycerol triacetate, alkyl citrates, azelates, dibenzoates, terephthalates, gluterates, organophosphates, polycarboxylate ether, polycarboxylate, sulfonated naphthalene condensate, and sulfonated melamine formaldehyde.

83. The composition of any one of claims 79-82, wherein the plasticizer is a low volatile organic compound (VOC) plasticizer.

84. The composition of any one of claims 1-83, wherein the asphalt-based sealcoat composition is highly solar reflective.

85. The composition of any one of claims 1-84, wherein the asphalt-based sealcoat has a SR (Solar Reflectivity) # of at least about 0.10.

86. The composition of any one of claims 1-85, wherein the asphalt-based sealcoat has a SR # of at least about 0.20.

87. The composition of any one of claims 1-86, wherein the asphalt-based sealcoat has a SR # of at least about 0.30.

88. The composition of any one of claims 1-87, wherein the asphalt-based sealcoat has a SR # of at least about 0.33.

89. The composition of any one of claims 1-88, wherein the asphalt-based sealcoat has a SR # of at least about 0.35.

90. The composition of any one of claims 1-86, wherein the asphalt-based sealcoat has a SR # of from about 0.20 to about 0.60.

91. The composition of any one of claims 1-90, wherein the asphalt-based sealcoat has an SRI (Solar Reflective Index) # of at least about 10.

92. The composition of any one of claims 1-91, wherein the asphalt-based sealcoat has an SRI # of at least about 20.

93. The composition of any one of claims 1-92, wherein the asphalt-based sealcoat has an SRI # of at least about 30.

94. The composition of any one of claims 1-93, wherein the asphalt-based sealcoat has an SRI # of at least about 35.

95. The composition of any one of claims 1-92, wherein the asphalt-based sealcoat has an SRI # of from about 20 to about 60.

96. The composition of any one of claims 1-95, wherein the asphalt-based sealcoat composition reduces surface temperatures of asphalt treated with the asphalt-based sealcoat composition compared to asphalt not treated with asphalt-based sealcoat composition.

97. The composition of any one of claims 1-96, further comprising a pigment present in an amount of about 0.01% to about 5% by weight.

98. The composition of claim 97, wherein the pigment is present in an amount of from about 0.05% to about 1% by weight.

99. The composition of claim 97 or claim 98, wherein the pigment is present in an amount of from about 0.1% to about 0.5% by weight.

100. The composition of any one of claims 97-99, wherein the pigment is an infrared reflective, dark pigment.

101. The composition of any one of claims 97-100, wherein the pigment is selected from the group consisting of red iron oxides, yellow iron oxides, phthalocyanine blue, perelyene black, chromic oxides (Cr₂O₃), ferric oxides (Fe₂O₃), white titanates, yellow titanates, green titanates, brown titanates, brown iron oxides, black iron oxides, miceous iron oxides, cadmium orange, cadmium yellow, and chromium iron oxides.

102. The composition of any one of claims 97-101, wherein the pigment is chromium green-black hematite.

103. The composition of any one of claims 1-102, wherein the TiO₂ particles comprise an anatase powder form of TiO₂.

104. The composition of any one of claims 1-102, wherein the TiO₂ particles comprise a brookite powder form of TiO₂.

105. The composition of any one of claims 1-102, wherein the TiO₂ particles comprise a rutile powder form of TiO₂.

106. The composition of any one of claims 1-105, wherein each respective TiO₂ particle in the plurality of TiO₂ particles comprises a modifier.

107. The composition of claim 106, wherein the modifier is an aluminum hydroxide coating.

108. The composition of any one of claims 1-107, wherein each respective TiO₂ particle in the plurality of TiO₂ particles has a size of no more than 20 microns.

109. The composition of any one of claims 1-108, wherein each respective TiO₂ particle in the plurality of TiO₂ particles has a size of no more than 10 microns.

110. The composition of any one of claims 1-109, wherein each respective TiO₂ particle in the plurality of TiO₂ particles has a size of no more than 5 microns.

111. The composition of any one of claims 1-110, further comprising an asphalt reinforcement component.

112. The composition of claim 111, wherein the asphalt reinforcement component is selected from the group consisting of mineral asphaltenes, clarified asphalt, and bio-based asphalt-like binders.

113. The composition of any one of claims 1-112, wherein the asphalt-based sealcoat composition reduces pollutants.

114. The composition of claim 113, wherein the asphalt-based sealcoat composition reduces atmospheric pollutants including an amount of nitrogen oxides (NOx) and volatile organic compounds (VOC) via photocatalytic reactions.

115. The composition of claim 113 or claim 114, wherein the asphalt-based sealcoat composition is highly solar reflective and reduces asphalt surface temperatures and pollutants.

116. The composition of any one of claims 113-115, wherein the asphalt-based sealcoat composition has a SR (Solar Reflectivity) # of at least about 0.33 and reduces asphalt surface temperatures and pollutants.

117. The composition of any one of claims 1-116, wherein the asphalt-based sealcoat has a skid number (SN40R) of at least about 25.

118. The composition of any one of claims 1-117, wherein the asphalt-based sealcoat has an SN40R of at least about 30.

119. The composition of any one of claims 1-118, wherein the asphalt-based sealcoat has an SN40R of at least about 35.

120. The composition of any one of claims 1-119, wherein the asphalt-based sealcoat has a dynamic friction test (DFT) value of at least about 0.35.

121. The composition of any one of claims 1-120, wherein the asphalt-based sealcoat has a DFT value of at least about 0.4.

122. The composition of any one of claims 1-121, wherein the asphalt-based sealcoat has a DFT value of at least about 0.45.

123. The composition of any one of claims 1-122, further comprising a dirt-resistance additive.

124. The composition of claim 123, wherein the dirt-resistance additive is colloidal silica.

125. A method for treating an asphalt surface, the method comprising:
applying an amount of an asphalt-based sealcoat composition of any of claims 1-124 to an upper surface of the asphalt surface.

126. The method of claim 125, wherein at the time of application the asphalt-based sealcoat composition is diluted with 1% to 50% additional water.

127. The method of claim 125 or claim 126, wherein at the time of application the asphalt-based sealcoat composition is diluted with 10% to 30% additional water.

128. The method of any one of claims 125-127, wherein at the time of application the asphalt-based sealcoat composition is diluted with 15% to 25% additional water.

129. The method of any one of claims 125-128, wherein at the time of application the asphalt-based sealcoat composition is diluted with 20% additional water.

130. The composition of any one of claims 1-124, wherein the TiO₂ particles are doped with one or more modifiers selected from the group consisting of sulfur, vanadium, zinc, silver, aluminum, copper, iron, manganese, nickel, chromium, tin, barium, strontium, magnesium, cobalt, boron, molybdenum, tungsten, carbon, phosphorus, platinum, gold, and nitrogen.
